(19) United States
(12) Patent Application Publication
(10) Pub. No.: US 2021/0227420 A1
(43) Pub. Date: Jul. 22, 2021

(54) SYSTEMS AND METHODS FOR ELECTROMAGNETIC VIRUS INACTIVATION

(71) Applicant: Rearden, LLC, Mountain View, CA (US)

(72) Inventors: Stephen G. Perlman, Alo Alto, CA (US); Antonio Forenza, San Francisco, CA (US); Robert W. Heath, Austin, TX (US); Fadi Saibi, Sunnyvale, CA (US); Michael Cheponis, Santa Clara, CA (US)

(21) Appl. No.: 17/224,977

(22) Filed: Apr. 7, 2021

Related U.S. Application Data
(63) Continuation-in-part of application No. 16/208,895, filed on Dec. 4, 2018.
Application No. 16/208,895 is a continuation of application No. 14/086,700, filed on Nov. 21, 2013, now Pat. No. 10,194,346.
Application No. 14/086,700 is a continuation-in-part of application No. 14/611,565, filed on Feb. 2, 2015.
Application No. 14/611,565 is a continuation-in-part of application No. 15/792,610, filed on Oct. 24, 2017.
Application No. 15/792,610 is a continuation-in-part of application No. 15/682,076, filed on Aug. 21, 2017.
Application No. 15/682,076 is a continuation-in-part of application No. 14/672,014, filed on Mar. 27, 2015.
(60) Provisional application No. 63/007,358, filed on Apr. 8, 2020.
(60) Provisional application No. 61/729,990, filed on Nov. 26, 2012.
(60) Provisional application No. 61/937,273, filed on Feb. 7, 2014.
(60) Provisional application No. 62/380,126, filed on Aug. 26, 2016.
(60) Provisional application No. 61/980,479, filed on Apr. 16, 2014.

(51) Int. Cl. H04W 28/02; H04B 7/024

(52) U.S. Cl. CPC H04W 28/0236; H04B 7/0417; H04B 7/024

(57) ABSTRACT

A system and method to reduce the number of active targeted viruses, bacteria or other microbes or microorganisms within an indoor or outdoor space using an array of radio frequency antennas, lasers or acoustic emitters is presented. The system sweeps through a series of beam patterns. The radio, laser or acoustic frequency and dwell time depend on the targeted viruses and bacteria. By sweeping through a wide range of transmit beamforming vectors, it is possible to kill or render harmless microbes or microorganisms at many locations throughout the coverage area while avoiding exposing humans to harmful levels of radio frequency or laser power. The proposed system and method can be flexibly applied to many array geometries including those with large spacing and non-isotropic antennas or acoustic emitters, as well to a variety of type of lasers.

### CROSS REFERENCE TO RELATED APPLICATIONS

This application claims the benefit of and priority to co-pending U.S. Provisional Patent Application No. 63/007,358, filed Apr. 8, 2020, entitled, “Systems and Methods for Electromagnetic Virus Inactivation”.

This application is a continuation-in-part of U.S. patent application Ser. No. 16/208,895, entitled, “Systems And Methods For Exploiting Inter-Cell Multiplexing Gain In Wireless Cellular Systems Via Distributed Input Distributed Output Technology”, filed Dec. 4, 2018, and which is a continuation of U.S. patent application Ser. No. 14/086,700, filed Nov. 21, 2013, now U.S. Pat. No. 10,194,346, issued on Jan. 29, 2019, and which also claims the benefit of co-pending U.S. Provisional Application No. 61/729,990, entitled, “Systems And Methods For Exploiting Inter-Cell Multiplexing Gain In Wireless Cellular Systems Via Distributed Input Distributed Output Technology”, filed Nov. 26, 2012, which is assigned to the assignee of the present application.

This application is also a continuation-in-part of U.S. application Ser. No. 14/611,565, filed Feb. 2, 2015, entitled “System And Method For Mapping Virtual Radio Instances Into Physical Areas of Coherence in Distributed Antenna Wireless Systems”, which also claims the benefit of and priority to co-pending U.S. Provisional patent Application No. 61/937,273, filed, Feb. 7, 2014, entitled, “Systems And Methods For Mapping Virtual Radio Instances Into Physical Areas Of Coherence In Distributed Antenna Wireless Systems”. U.S. application Ser. No. 14/611,565 is a continuation in part of the following four U.S. patents, (1) U.S. application Ser. No. 13/844,355, filed Mar. 15, 2013, now U.S. Pat. No. 10,547,358, issued Jan. 28, 2020, entitled “System and Methods for Radio Frequency Calibration Exploiting Channel Reciprocity in Distributed Input Distributed Output Wireless Communications”, (2) U.S. application Ser. No. 13/797,984, filed Mar. 12, 2013, now U.S. Pat. No. 9,973,246 issued May 15, 2018, entitled “System and Methods for Exploiting Inter-Cell Multiplexing Gain in Wireless Cellular Systems Via Distributed Input Distributed Output Technology”, (3) U.S. application Ser. No. 13/797,971, filed Mar. 12, 2013, now U.S. Pat. No. 9,923,657, issued Mar. 20, 2018, entitled “System and Methods for Exploiting Inter-Cell Multiplexing Gain in Wireless Cellular Systems Via Distributed Input Distributed Output Technology”, and (4) U.S. application Ser. No. 13/797,950, filed Mar. 12, 2013, now U.S. Pat. No. 10,164,698, issued Dec. 25, 2018, entitled “System and Methods for Exploiting Inter-Cell Multiplexing Gain in Wireless Cellular Systems Via Distributed Input Distributed Output Technology”.

This application claims is also a continuation-in-part of U.S. patent application Ser. No. 15/792,610, entitled, “Systems and Methods for Distributing Radioheads”, filed Oct. 24, 2017, which is a continuation-in-part of co-pending U.S. application Ser. No. 15/682,076, filed Aug. 21, 2017, entitled “Systems And Methods For Mitigating Interference Within Actively Used Spectrum”, which claims the benefit of and priority to U.S. Provisional Application No. 62/380,126, filed Aug. 26, 2016, entitled “Systems and Methods for Mitigating Interference within Actively Used Spectrum” and is also a continuation-in-part of U.S. application Ser. No. 14/672,014, filed Mar. 27, 2015, entitled “Systems and Methods for Concurrent Spectrum Usage Within Actively Used Spectrum” which claims the benefit of and priority to co-pending U.S. Provisional Patent Application No. 61/980,479, filed Apr. 16, 2014, entitled, “Systems and Methods for Concurrent Spectrum Usage Within Actively Used Spectrum”.

These applications are herein incorporated by reference in their entirety.

### RELATED APPLICATIONS

This application may be related to the following issued and co-pending U.S. patent applications:

U.S. Provisional Application No. 63/007,358, filed Apr. 8, 2020, entitled, “Systems and Methods for Electromagnetic Virus Inactivation”

U.S. Pat. No. 10,547,358, issued Jan. 28, 2020, entitled “System and Methods for Radio Frequency Calibration Exploiting Channel Reciprocity in Distributed Input Distributed Output Wireless Communications”

U.S. Pat. No. 10,425,134, issued Sep. 24, 2019, entitled “System and Methods for planned evolution and obsolescence of multiuser spectrum”

U.S. Pat. No. 10,349,417, issued Jul. 9, 2019, entitled “System and Methods to Compensate for Doppler Effects in Distributed-Input Distributed Output Systems”

U.S. Pat. No. 10,333,604, issued, Jun. 25, 2019, entitled “System and Method For Distributed Antenna Wireless Communications”

U.S. Pat. No. 10,320,455, issued Jun. 11, 2019, entitled “Systems and Methods to Coordinate Transmissions in Distributed Wireless Systems via User Clustering”

U.S. Pat. No. 10,277,290, issued Apr. 20, 2019, entitled “Systems and Methods to Exploit Areas of Coherence in Wireless Systems”

U.S. Pat. No. 10,243,623, issued Mar. 26, 2019, entitled “System and Methods to Enhance Spatial Diversity in Distributed-Input Distributed-Output Wireless Systems”

U.S. Pat. No. 10,200,094, issued Feb. 5, 2019, entitled “Interference Management, Handoff, Power Control And Link Adaptation In Distributed-Input Distributed-Output (DIDO) Communication Systems”

U.S. Pat. No. 10,187,133, issued Jan. 22, 2019, entitled “System And Method For Power Control And Antenna Grouping In A Distributed-Input-Distributed-Output (DIDO) Network”

U.S. Pat. No. 10,164,698, issued Dec. 25, 2018, entitled “System and Methods for Exploiting Inter-Cell Multiplexing Gain in Wireless Cellular Systems Via Distributed Input Distributed Output Technology”

U.S. Pat. No. 9,973,246, issued May 15, 2018, entitled “System and Methods for Exploiting Inter-Cell Multiplexing Gain in Wireless Cellular Systems Via Distributed Input Distributed Output Technology”

U.S. Pat. No. 9,923,657, issued Mar. 20, 2018, entitled “System and Methods for Exploiting Inter-Cell Multiplexing Gain in Wireless Cellular Systems Via Distributed Input Distributed Output Technology”

U.S. Pat. No. 9,826,537, issued Nov. 21, 2017, entitled “System And Method For Managing Inter-Cluster Handoff Of Clients Which Traverse Multiple DIDO Clusters”

U.S. Pat. No. 9,819,403, issued Nov. 14, 2017, entitled “System And Method For Managing Handoff Of A Client Between Different Distributed-Input-Distributed-Output (DIDO) Networks Based On Detected Velocity Of The Client”

U.S. Pat. No. 9,685,997, issued Jun. 20, 2017, entitled “System and Methods to Enhance Spatial Diversity in Distributed-Input Distributed-Output Wireless Systems”

U.S. Pat. No. 9,386,465, issued, Jul. 5, 2016, entitled “System and Method For Distributed Antenna Wireless Communications”

U.S. Pat. No. 9,369,888, issued Jun. 14, 2016, entitled “Systems and Methods to Coordinate Transmissions in Distributed Wireless Systems via User Clustering”

U.S. Pat. No. 9,312,929, issued Apr. 12, 2016, entitled “System and Methods to Compensate for Doppler Effects in Distributed-Input Distributed Output Systems”

U.S. Pat. No. 8,989,155, issued Mar. 24, 2015, entitled “System and Methods for Wireless Backhaul in Distributed-Input Distributed-Output Wireless Systems”

U.S. Pat. No. 8,971,380, issued Mar. 3, 2015, entitled “System And Method For Adjusting DIDO Interference Cancellation Based On Signal Strength Measurements”

U.S. Pat. No. 8,654,815, issued Feb. 18, 2014, entitled “System and Method For Distributed Antenna Wireless Communications”

U.S. Pat. No. 8,571,086, issued Oct. 29, 2013, entitled “System And Method For DIDO Precoding Interpolation In Multicarrier Systems”

U.S. Pat. No. 8,542,763, issued Sep. 24, 2013, entitled “Systems and Methods to Coordinate Transmissions in Distributed Wireless Systems via User Clustering”

U.S. Pat. No. 8,428,162, issued Apr. 23, 2013, entitled “System and Method for Distributed Input Distributed Output Wireless Communication”

U.S. Pat. No. 8,170,081, issued May 1, 2012, entitled “System And Method For Adjusting DIDO Interference Cancellation Based On Signal Strength Measurements”

U.S. Pat. No. 8,160,121, issued Apr. 17, 2012, entitled, “System and Method For Distributed Input-Distributed Output Wireless Communications

U.S. Pat. No. 7,885,354, issued Feb. 8, 2011, entitled “System and Method For Enhancing Near Vertical Incidence Skywave (“NVIS”) Communication Using Space-Time Coding”

U.S. Pat. No. 7,711,030, issued May 4, 2010, entitled “System and Method For Spatial-Multiplexed Tropospheric Scatter Communications”

U.S. Pat. No. 7,636,381, issued Dec. 22, 2009, entitled “System and Method for Distributed Input Distributed Output Wireless Communication”

U.S. Pat. No. 7,633,994, issued Dec. 15, 2009, entitled “System and Method for Distributed Input Distributed Output Wireless Communication”

U.S. Pat. No. 7,599,420, issued Oct. 6, 2009, entitled “System and Method for Distributed Input Distributed Output Wireless Communication”

U.S. Pat. No. 7,418,053, issued Aug. 26, 2008, entitled “System and Method for Distributed Input Distributed Output Wireless Communication”

U.S. application Ser. No. 16/578,265, filed Sep. 20, 2019, entitled “System And Method For Planned Evolution and Obsolescence of Multiuser Spectrum”

U.S. application Ser. No. 16/253,028, filed Jan. 21, 2019, entitled “System And Methods to Enhance Spatial Diversity in Distributed-Input Distributed-Output Wireless Systems”

U.S. application Ser. No. 16/505,593, filed Jul. 8, 2019, entitled “System And Method to Compensate for Doppler Effects in Multi-user (MU) Multiple Antenna Systems (MAS)”

U.S. application Ser. No. 16/436,864, filed Jun. 10, 2019, entitled “Systems And Methods to Coordinate Transmissions in Distributed Wireless Systems via User Clustering”

U.S. application Ser. No. 16/188,841, filed Nov. 13, 2018, entitled “Systems And Methods For Exploiting Inter-Cell Multiplexing Gain In Wireless Cellular Systems Via Distributed Input Distributed Output Technology”

U.S. application Ser. No. 15/792,610, filed Oct. 24, 2017, entitled “System And Method For Distributing Radioheads”

U.S. application Ser. No. 15/682,076, filed Aug. 21, 2017, entitled “System And Method For Mitigating Interference within Actively Used Spectrum”

U.S. application Ser. No. 15/340,914, filed Nov. 1, 2016, entitled “System And Method For Distributed Input Distributed Output Wireless Communication”

U.S. application Ser. No. 14/672,014, filed Mar. 27, 2015, entitled “System And Method For Concurrent Spectrum Usage within Actively Used Spectrum”

U.S. application Ser. No. 14/611,565, filed Feb. 2, 2015, entitled “System And Method For Mapping Virtual Radio Instances Into Physical Areas of Coherence in Distributed Antenna Wireless Systems”

U.S. application Ser. No. 12/802,975, filed Jun. 16, 2010, entitled “System And Method For Link adaptation In DIDO Multicarrier Systems”

### BACKGROUND

Viruses are essentially a genome (RNA or DNA) surrounded by a protein coat or capsid. A nucleocapsid consists of a capsid with the enclosed nucleic acid, and it is generally inside the cytoplasm. Depending on the virus the nucleocapsid may be surrounded by a membranous envelope. For example, the nucleocapsid protein (N-protein) is the most abundant protein in a coronavirus, and the N-protein is often used as a marker in diagnostic assays. The nucleocapsid is formed from an association of the N protein with the viral RNA or DNA (see FIG. 1).

Viruses latch onto cells, especially those that are weak or lack a protective skin, and then multiply. Unlike bacteria, antibiotics cannot control viruses. A limited number of antiviral remedies and vaccines are available for some common viruses, like strains of seasonal influenza, but these remedies need constant redevelopment as viruses mutate and evolve. There are no complete remedies for many viruses, HIV being a prime example.

Vaccines can be developed to prevent or reduce the likelihood of infection from viruses, but typically take longer to develop for new viruses and to confirm to be effective and not dangerous, far slower than the speed new viruses spread through the developed world [15].

For example, SARS-CoV-2 (previously known as 2019 novel coronavirus, causing a respiratory illness known as COVID-19) resulted in a global pandemic and claimed many thousands of lives long before any vaccine was available. The earliest case of infection apparently was found on Nov. 17, 2019 in Hubei, China, and the virus quickly spread to all provinces of China and to over 180 countries in Asia, Europe, North America, South America, Africa and Oceania, apparently largely through human-to-human transmission. Less than 3 months after first detection, on Jan. 30, 2020, the World Health Organization (“WHO”) declared SARS-CoV-2 a Public Health Emergency of International concern, and less than 4 months after the first detection, on Mar. 11, 2020, the WHO declared it a global pandemic. By Apr. 8, 2020, over 1.5 million people had been infected, with over 88,000 deaths. Death rates varied widely by country for a wide range of factors, such as how early in the outbreak quarantine and social distancing measures were put into effect, the average age of the population, the availability of medical facilities, cultural norms related to human contact, and many other factors [16].

Pure chance was a major factor in who was infected or not, and who lived and died. For example, the Life Care Center nursing home in Kirkland, Wash. with approximately 120 residents, many in their 80s and 90s, became the epicenter of the first major SARS-CoV-2 outbreak in the U.S. It is as yet unknown what infected individual visited the facility and who they first transmitted the virus to, but on Feb. 26, 2020 the first 2 residents died from the virus, and as many other residents rapidly became ill with similar symptoms, the facility was quarantined and the virus was identified as SARS-CoV-2. As of Mar. 21, 2020, 81 residents, two-thirds of its population, have tested positive for SARS-CoV-2, and 35 residents have died, 43% of the infected residents. One-third of its staff either became ill or stayed home to avoid infection [1].

Some viruses are contagious before there are symptoms, as is believed to be case with SARS-CoV-2, and are spread by people unaware they are carriers. Some viruses have very high fatality rate, such as 2014-2016 Ebola (estimated at 50% fatality rate), other viruses have very low fatality rates, such as H1N1 influenza strain that resulted in the 2009 pandemic (estimated fatality rate of 0.02%) [18]. Even common viruses like seasonal influenza have a major impact in many ways through illness (discomfort, loss of productivity, medical costs) and in more serious cases death (especially at risk, depending on the virus, are children, the elderly, those with compromised immune systems and those who have preexisting medical conditions).

The SARS-CoV-2 pandemic rapidly resulted in hundreds of millions of people being quarantined (e.g. restricted to their homes except for travel to get essentials such as food, medicine, medical help, or to support essential services) so as to prevent the spread of the virus. By Apr. 7, 2020, about 95% of Americans were staying at home to prevent spread of the virus [19]. The consequence was an unprecedented disruption throughout the developed world to the daily lives of people and institutions, including schools, businesses, and government offices.

The reason for such severe measures on such a massive scale is that quarantine and social distancing are the only feasible ways to slow down the growth rate of contagion in developed countries, where people interact in large groups and travel extensively all over the world, to prevent overwhelming available healthcare resources. For example, severe cases of SARS-CoV-2 require a medical ventilator for treatment, and there are a limited number of ventilators available in the healthcare system of each region of each country. If a large number of people get sick all at once, there will not be enough ventilators to go around, resulting in otherwise avoidable deaths, but if the same number of people get sick spread over a long enough time, then there will be enough ventilators.

Some viruses remain active in aerosol form (in the air) or on surfaces for many hours or even days, depending on temperature and humidity conditions or type of surfaces. For example, recent publications have shown that SARS-CoV-2 remains active in aerosol form for up to 3 hours and on surfaces, depending on the type of material, for up to 72 hours [20],[21].

While there are broad spectrum chemicals, and sterilization techniques, such as intense ultraviolet light or extreme heat, available that can be used to inactivate viruses on surfaces and in the air, these products and techniques must be applied frequently and specifically to potential areas of contact to be most effective. They work best in places that can be sprayed or washed (like desktop surfaces) but are less effective in hidden locations (under a chair desk) or generally in the air. Further, in public spaces, like stadiums, concert halls, transportation stations, schools, etc., it may be impractical to manually clean all exposed surfaces using chemicals after each time the public space is used to prevent spread of viruses.

However, no matter how often or thoroughly a public space is cleaned, it will have little impact in controlling contagion for many viruses, including SARS-CoV-2, which spread primarily through aerosol infection from person to person. For example, one person who is contagious with an active virus coughs in a train station packed with people can infect dozens of people near them through aerosol exposure, regardless of how well the train station was cleaned the night before. It is reported that outbreak of the coronavirus epidemic at the beginning of the year 2020 was caused by mass gatherings in public areas and indoor venues in different countries, such as the Chinese Lunar New Year banquet in Wuhan, China [22], the Sunday mass at the Shincheonji church in Daegu, South Korea [23], or the soccer game at the San Siro stadium in Milan, Italy [24]. Other examples where the same virus spread quickly in confined environments are the Diamond Princess cruise ship docked in Yokohama, Japan [25] and the US aircraft carrier USS Theodore Roosevelt in Guam [26].

Consequently, there is interest in developing new techniques that can inactive viruses in aerosol form in real-time, before one person can infect others through direct aerosol exposure, particularly in public areas or venues with high densities of people. This would require inactivating the virus in aerosol form after a violent expiratory event, such as a cough or a sneeze, before the virus in aerosol form comes into contact with another person. It would also require a means that can inactivate the aerosol form of the virus while it is very close to humans without causing harm to the humans.

Air ionizers have been shown to suppress virus transmission in aerosol form in indoor spaces [27], but a side-effect of air ionizers is production of indoor ozone, potentially in excess of the Food and Drug Administration's limit of 0.05 parts per million (ppm) for medical devices [28], and by the Occupational Safety and Hazard Administration for 0.10 ppm for 8 hours, and by the National Institute of Occupational Safety and Health for 0.10 ppm not to be exceeded at any time. Ozone is a lung irritant that can decrease lung function, aggravate asthma and result in throat irritation and cough, chest pain and shortness of breath, inflammation of lung tissue and higher susceptibility to respiratory infection [29]. As a result, air ionizers would be problematic to use at large scale in public spaces as a means to suppress airborne viruses

Another proposed approach is to use far ultraviolet-C light in the 202-222 nm range in overhead lights in public spaces to kill both viruses and bacteria [30]. Such an approach would be similar to conventional ultraviolet disinfection, but other studies suggest that, unlike longer ultraviolet wavelengths that have adverse effects (e.g. cancer and cornea and retinal damage) on human skin and eyes, far ultraviolet-C light in the 202-222 nm range does not [31]. While this may ultimately prove to be a viable solution, until there are long-term studies and widely-accepted standards for extended human exposure of ultraviolet-C light in the 202-222 nm range, it will not be feasible to use this approach in public spaces.

An alternative to inactivating viruses with chemicals, air ionization, ultraviolet light or extreme heat before they enter the body is to exploit resonance of the special symmetry in the viral capsids or nucleocapsids, which contain the virus RNA or DNA. This symmetry manifests in the presence of many low frequency vibrational modes that can be excited with ultrasound or hypersound signals, hypothesized in [1] and later calculated using a mathematical formulation in [2], and see also [3].

The symmetry in the viral capsids can also be exploited using Electromagnetic (“EM”) radiation. The concept of using EM radiation to rupture the capsid of a virus is discussed in [5] and implemented in the near field over very short distances in [32]. All molecules have vibrational and rotational resonant frequencies that strongly absorb incident EM radiation. Rotational resonant frequencies are typically absorbed in the microwave regime, compared with vibrational resonant frequencies that require infrared or similarly very high frequencies. The absorbed EM energy is then converted to heat the molecule and its surroundings. It has been shown in [32] that with enough energy, a target molecule in the capsid could generate enough heat to rupture the virus, thereby destroying the capsid and its viral genome content and thus inactivating the virus. The critical step would be to find a relatively unique molecule in a capsid for a target virus and excite only this virus. The article in [5] imagines this would be done in vivo (once the virus is already in the body) but does not provide a solution. [32] describes a working system to inactivate viruses outside of the body, where influenza A subtypes H3N2 and H1N1 viruses in solution were inactivated by exposure to microwave radiation at frequencies between 6 and 12 GHz, as shown in FIG. 2.

EM radiation may also be used in other ways to inactivate a virus. For example, in [6] it is hypothesized that the high pressure inside a capsid with viral genome that has a crystalline form could be exploited by resonance with an EM signal at corresponding frequency to the lattice vibration frequency.

Prior art EM radiation development has been focused on short-distance transmission. [32] utilized a microwave horn with the virus specimen located within a few centimeters of the horn. [33] described combining a microwave horn with a focusing reflectarray in the near field for inactivating the H3N2 influenza-A subtype with the specimens at distances up 178 mm (7 inches).

These prior art solutions are practical when no humans are exposed to the EM radiation. For example, if humans are cleared out of a public space, then powerful ultraviolet lamps or microwave emitters can be turned on to flood the public space with EM radiation and inactivate viruses remaining in the air or on surfaces. Also, handheld ultraviolet lamps or microwave transmitters can be pointed at specific surfaces to deactivate viruses. But, as previously noted much, if not almost all, virus contagion occurs through real-time human-to-human aerosol transmission. These prior art solutions do not address this primary means of virus transmission.

As previously noted, prior art far ultraviolet-C light in the 202-222 nm range in overhead lights in public spaces may be ultimately found to be safe for long-term human exposure at some power level that also inactivates viruses. If so, a means will have to be found to be sure that there is sufficient power level to inactivate the virus, but low enough power level to not harm humans, and can be maintained where humans are located. If the distance between the ultraviolet light sources and humans varies greatly, this could be difficult to achieve because the power received by both the aerosol virus and the humans will vary dramatically depending on the distance. Light radiation generally, and ultraviolet light radiation in particular, is much more difficult to control than microwave radiation. 202 nm light has a frequency of about 1.5 petahertz, about 185,000 times higher frequency than, for example, 8 GHz microwave radiation, and as such, there are fewer technologies available to control its power level at particular locations in a public space.

[32] states that the power levels necessary to inactivate the virus is below the IEEE safety standard [34], but such levels would provide partial virus inactivation, and only after 15 minutes. On page 6 [32] states, “Our theoretical model predicted an inactivation threshold field intensity of 86.9 V/m, corresponding to an average microwave power density of 82.3 W/m² in specimen. Since we assume all power can transmit from air to specimen, power density in air is also 82.3 W/m², which is 1.48 times lower than the IEEE safety standard”, but 82.3 W/m² corresponded to a 38% virus inactivation. To achieve 100% virus inactivation, a power density of 810 W/m² is required. Further, the experiments exposed the virus samples to these power levels for 15-minute intervals, far too long to deactivate airborne virus transmitted in real-time from one human to another in droplets from a cough or sneeze.

The paper references the IEEE safety standards, but there are other safety guidelines for microwave emissions that will likely be applicable for wide public adoption particularly in the United States, including EM exposure guidelines from the FCC [35],[36] and the International Commission on Non-Ionizing Radiation Protection (ICNIRP at www.icinirp.org) [43]. The ICNIRP guidelines were very recently updated on Mar. 11, 2020, taking into account recent studies. The ICNIRP and FCC EM radiation exposure guidelines are quite similar, they indicate a power density limit of 10 W/m² at frequencies above 1.5 GHz for general population/uncontrolled whole-body exposures, and both are more restrictive than the IEEE guidelines used by [32]. The power density of 82.3 W/m² for 38% virus inactivation after 15 minutes described in [32] would be far beyond the ICNIRP or FCC EM exposure guidelines, let alone 810 W/m², for 100% inactivation after 15 minutes. It is likely that higher power will be needed to inactivate viruses within seconds or less to prevent human-to-human airborne contagion in the event of a cough or a sneeze in a public space.

Lasers have been used to inactivate viruses in lab environments, where humans are not exposed to the laser emissions, by impulsive stimulated Raman scattering (ISRS) using femtosecond lasers [4],[37]. ISRS consists of irradiating the virus with an intense ultrashort pulsed laser to excite vibrational modes and produce low frequency acoustic vibrations that rupture the capsid of the virus. Different viruses exhibit different vibrational frequencies that can be synthesized by changing the pulse width of the laser. Laser emissions at sufficient power to inactivate viruses would be potentially harmful to the human eye or skin. Lasers are classified by U.S. Food and Drug Administration (FDA) as Class I, Class IIa and II, Class IIIa and IIIb, and Class IV, with similar classifications by the International Electrotechnical Commission (IEC) classifications Class 1, 1M, Class 2, 2M, Class 3R, 3B, and Class 4. (e.g., [38]). Class I and Class 1 is considered non-hazardous when viewed by the naked eye. Classes IIa and II, and Classes 2 and 2M are considered non-hazardous when viewed by the naked eye for short periods of time. Classes IIIa and Class 3R, depending on the power, can be momentarily hazardous when directly by the naked eye. Class IIIb and Class 3B is an immediate skin hazard from a direct beam and immediate eye hazard when viewed directly by the naked eye. Class IV and Class 4 is an immediate skin hazard and eye hazard to either a direct or reflected beam and may also present a fire hazard. For lasers safely viewed directly by the naked eye in a public space, only Class I can be used continuously, and only Classes IIa and II, potentially Class IIIa at low enough power can be used to scan over a public space. If lasers were used to inactivate viruses near the faces of humans in a public space, higher power than safe power levels of stationary or scanning Classes I, IIa, II, or IIIa lasers would be required, but such lasers would not be safe to use without risking harm to humans.

Thus, while there are known EM radiation methods for inactivating viruses, there are obstacles to widespread deployment. The exposure limits are not yet established in the case of far ultraviolet C radiation in the 202-222 nm range and it may be difficult to control the power level of the radiation in a public space. In the case of microwave radiation, the required power levels using known techniques are far in excess of established human EM radiation exposure guidelines by the ICNIRP and FCC. In the case of laser emissions, the laser power required to inactivate viruses would risk harm to humans.

There is an urgent need to provide systems and methods to inactivate airborne viruses in real-time public spaces to prevent human-to-human airborne contagion. These systems and methods inactivate airborne viruses in public spaces that have just been released through violent expiratory events (e.g. coughing or sneezing) by humans, but they must be safe—in accordance with accepted EM radiation exposure guidelines—for all of the humans in the public spaces.

### BRIEF DESCRIPTION OF THE DRAWINGS

The patent or application file contains at least one drawing executed in color. Copies of this patent or patent publication with color drawing(s) will be provided by the U.S. Patent and Trademark Office upon request and payment of the necessary fee.

A better understanding of the present invention can be obtained from the following detailed description in conjunction with the drawings, in which:

FIG. 1 illustrates a virus virion.

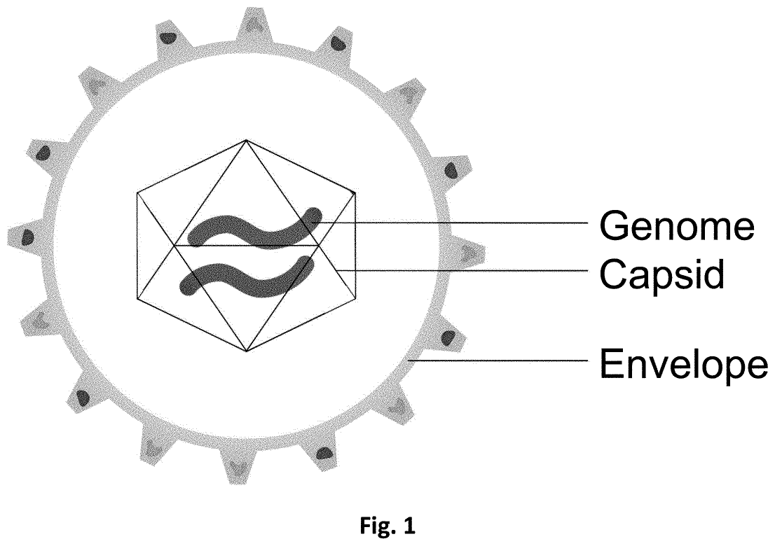

FIG. 2 illustrates inactivation ratios at different resonant frequencies in accordance with prior art.

FIG. 3 illustrates the components of the system under consideration.

FIG. 4 illustrates the geometry of 6×6 squared array.

FIG. 5 illustrates the array factor of 6×6 squared array.

FIG. 6 illustrates the radiation density towards the direction of maximum gain of the squared array (i.e., broadside direction) as a function of distance and total number of transmit antennas.

FIG. 7 illustrates the average transmit power requirement to rupture the capsid of the HRV by increasing the temperature from 30° C. to 45° C. for 20 minutes.

FIG. 8 illustrates the −3 dB beamwidth of squared array as a function of the number of antennas.

FIG. 9 illustrates a stadium as an exemplary public space in accordance with an embodiment of the present invention.

FIG. 10 illustrates a public space with antennas or BTSs distributed throughout and a controller and switch in accordance with an embodiment of the present invention.

FIGS. 11a and 11b illustrate public spaces with and without a roof configured with steerable beamforming antennas directed to a first section of the public space in accordance with an embodiment of the present invention.

FIGS. 12a and 12b illustrate public spaces with and without a roof configured with steerable beamforming antennas directed to a second section of the public space in accordance with an embodiment of the present invention.

FIGS. 13a and 13b illustrate public spaces with and without a roof configured with overlapping LIDAR units in accordance with an embodiment of the present invention.

FIGS. 14a and 14b illustrate public spaces with and without a roof configured with steerable beamforming antennas directed to a first section of the public space and with overlapping LIDAR units in accordance with an embodiment of the present invention.

FIG. 15 illustrates a close-up view of 2 humans sitting in a public space with an inactivation volume around them in accordance with an embodiment of the present invention.

FIG. 16 illustrates an inactivation volume containing volumes of coherence in accordance with an embodiment of the present invention.

FIG. 17 illustrates volumes of coherence shown as a solid shade of gray in accordance with an embodiment of the present invention.

FIG. 18 is a 3D illustration of FIG. 17.

FIG. 19 illustrates a close-up view of 2 humans with one standing and one sitting in a public space with an inactivation volume containing volumes of coherence shown as a solid shade of gray in accordance with an embodiment of the present invention.

FIGS. 20a and 20b illustrate a public space shown with an inactivation volume containing volumes of coherence shown as a solid shade of gray in accordance with an embodiment of the present invention.

FIG. 21 illustrates a close-up view of 2 humans sitting in s public space with steerable lasers combining in an inactivation volume in accordance with an embodiment of the present invention.

FIG. 22 illustrates an exemplary embodiment of the invention with 100 antenna arrays installed on the ceiling of a section of an arena at the height of 10 meters above the seating area in accordance with an embodiment of the present invention.

FIG. 23 illustrates the spatial distribution of the power density in the section of the arena with free-space propagation in accordance with an embodiment of the present invention.

FIG. 24 illustrates the top view of the “safety boundary” in accordance with an embodiment of the present invention.

FIG. 25 illustrates the 3D view of the “safety boundary” in accordance with an embodiment of the present invention.

FIG. 26 illustrates the 3D view of the “inactivation boundary” encapsulated within the “safety boundary” in accordance with an embodiment of the present invention.

FIG. 27 illustrates the spatial distribution of the power density in the section of the arena with fast-fading propagation channel. in accordance with an embodiment of the present invention

### DETAILED DESCRIPTION

One solution to overcome many of the above prior art limitations is to inactivate airborne viruses in real-time using radio frequencies (RF) with an embodiment of a distributed antenna or base transceiver station (“BTS”) spatial processing commercially known as pCell® wireless technology (also called “Distributed-Input Distributed-Output” or “DIDO” wireless technology) as taught in the following patents and patent applications, all of which are assigned the assignee of the present patent and are incorporated by reference. These patents and applications are sometimes referred to collectively herein as the “Related patents and applications.”

U.S. Provisional Application No. 63/007,358, filed Apr. 8, 2020, entitled, “Systems and Methods for Electromagnetic Virus Inactivation”

U.S. Pat. No. 10,547,358, issued Jan. 28, 2020, entitled “System and Methods for Radio Frequency Calibration Exploiting Channel Reciprocity in Distributed Input Distributed Output Wireless Communications”

U.S. Pat. No. 10,425,134, issued Sep. 24, 2019, entitled “System and Methods for planned evolution and obsolescence of multiuser spectrum”

U.S. Pat. No. 10,349,417, issued Jul. 9, 2019, entitled “System and Methods to Compensate for Doppler Effects in Distributed-Input Distributed Output Systems”

U.S. Pat. No. 10,333,604, issued, Jun. 25, 2019, entitled “System and Method For Distributed Antenna Wireless Communications”

U.S. Pat. No. 10,320,455, issued Jun. 11, 2019, entitled “Systems and Methods to Coordinate Transmissions in Distributed Wireless Systems via User Clustering”

U.S. Pat. No. 10,277,290, issued Apr. 20, 2019, entitled “Systems and Methods to Exploit Areas of Coherence in Wireless Systems”

U.S. Pat. No. 10,243,623, issued Mar. 26, 2019, entitled “System and Methods to Enhance Spatial Diversity in Distributed-Input Distributed-Output Wireless Systems”

U.S. Pat. No. 10,200,094, issued Feb. 5, 2019, entitled “Interference Management, Handoff, Power Control And Link Adaptation In Distributed-Input Distributed-Output (DIDO) Communication Systems”

U.S. Pat. No. 10,187,133, issued Jan. 22, 2019, entitled “System And Method For Power Control And Antenna Grouping In A Distributed-Input-Distributed-Output (DIDO) Network”

U.S. Pat. No. 10,164,698, issued Dec. 25, 2018, entitled “System and Methods for Exploiting Inter-Cell Multiplexing Gain in Wireless Cellular Systems Via Distributed Input Distributed Output Technology”

U.S. Pat. No. 9,973,246, issued May 15, 2018, entitled “System and Methods for Exploiting Inter-Cell Multiplexing Gain in Wireless Cellular Systems Via Distributed Input Distributed Output Technology”

U.S. Pat. No. 9,923,657, issued Mar. 20, 2018, entitled “System and Methods for Exploiting Inter-Cell Multiplexing Gain in Wireless Cellular Systems Via Distributed Input Distributed Output Technology”

U.S. Pat. No. 9,826,537, issued Nov. 21, 2017, entitled “System And Method For Managing Inter-Cluster Handoff Of Clients Which Traverse Multiple DIDO Clusters”

U.S. Pat. No. 9,819,403, issued Nov. 14, 2017, entitled “System And Method For Managing Handoff Of A Client Between Different Distributed-Input-Distributed-Output (DIDO) Networks Based On Detected Velocity Of The Client”

U.S. Pat. No. 9,685,997, issued Jun. 20, 2017, entitled “System and Methods to Enhance Spatial Diversity in Distributed-Input Distributed-Output Wireless Systems”

U.S. Pat. No. 9,386,465, issued, Jul. 5, 2016, entitled “System and Method For Distributed Antenna Wireless Communications”

U.S. Pat. No. 9,369,888, issued Jun. 14, 2016, entitled “Systems and Methods to Coordinate Transmissions in Distributed Wireless Systems via User Clustering”

U.S. Pat. No. 9,312,929, issued Apr. 12, 2016, entitled “System and Methods to Compensate for Doppler Effects in Distributed-Input Distributed Output Systems”

U.S. Pat. No. 8,989,155, issued Mar. 24, 2015, entitled “System and Methods for Wireless Backhaul in Distributed-Input Distributed-Output Wireless Systems”

U.S. Pat. No. 8,971,380, issued Mar. 3, 2015, entitled “System And Method For Adjusting DIDO Interference Cancellation Based On Signal Strength Measurements”

U.S. Pat. No. 8,654,815, issued Feb. 18, 2014, entitled “System and Method For Distributed Antenna Wireless Communications”

U.S. Pat. No. 8,571,086, issued Oct. 29, 2013, entitled “System And Method For DIDO Precoding Interpolation In Multicarrier Systems”

U.S. Pat. No. 8,542,763, issued Sep. 24, 2013, entitled “Systems and Methods to Coordinate Transmissions in Distributed Wireless Systems via User Clustering”

U.S. Pat. No. 8,428,162, issued Apr. 23, 2013, entitled “System and Method for Distributed Input Distributed Output Wireless Communication”

U.S. Pat. No. 8,170,081, issued May 1, 2012, entitled “System And Method For Adjusting DIDO Interference Cancellation Based On Signal Strength Measurements”

U.S. Pat. No. 8,160,121, issued Apr. 17, 2012, entitled, “System and Method For Distributed Input-Distributed Output Wireless Communications

U.S. Pat. No. 7,885,354, issued Feb. 8, 2011, entitled “System and Method For Enhancing Near Vertical Incidence Skywave (“NVIS”) Communication Using Space-Time Coding”

U.S. Pat. No. 7,711,030, issued May 4, 2010, entitled “System and Method For Spatial-Multiplexed Tropospheric Scatter Communications”

U.S. Pat. No. 7,636,381, issued Dec. 22, 2009, entitled “System and Method for Distributed Input Distributed Output Wireless Communication”

U.S. Pat. No. 7,633,994, issued Dec. 15, 2009, entitled “System and Method for Distributed Input Distributed Output Wireless Communication”

U.S. Pat. No. 7,599,420, issued Oct. 6, 2009, entitled “System and Method for Distributed Input Distributed Output Wireless Communication”

U.S. Pat. No. 7,418,053, issued Aug. 26, 2008, entitled “System and Method for Distributed Input Distributed Output Wireless Communication”

U.S. application Ser. No. 16/578,265, filed Sep. 20, 2019, entitled “System And Method For Planned Evolution and Obsolescence of Multiuser Spectrum”

U.S. application Ser. No. 16/253,028, filed Jan. 21, 2019, entitled “System And Methods to Enhance Spatial Diversity in Distributed-Input Distributed-Output Wireless Systems”

U.S. application Ser. No. 16/505,593, filed Jul. 8, 2019, entitled “System And Method to Compensate for Doppler Effects in Multi-user (MU) Multiple Antenna Systems (MAS)”

U.S. application Ser. No. 16/436,864, filed Jun. 10, 2019, entitled “Systems And Methods to Coordinate Transmissions in Distributed Wireless Systems via User Clustering”

U.S. application Ser. No. 16/188,841, filed Nov. 13, 2018, entitled “Systems And Methods For Exploiting Inter-Cell Multiplexing Gain In Wireless Cellular Systems Via Distributed Input Distributed Output Technology”

U.S. application Ser. No. 15/792,610, filed Oct. 24, 2017, entitled “System And Method For Distributing Radioheads”

U.S. application Ser. No. 15/682,076, filed Aug. 21, 2017, entitled “System And Method For Mitigating Interference within Actively Used Spectrum”

U.S. application Ser. No. 15/340,914, filed Nov. 1, 2016, entitled “System And Method For Distributed Input Distributed Output Wireless Communication”

U.S. application Ser. No. 14/672,014, filed Mar. 27, 2015, entitled “System And Method For Concurrent Spectrum Usage within Actively Used Spectrum”

U.S. application Ser. No. 14/611,565, filed Feb. 2, 2015, entitled “System And Method For Mapping Virtual Radio Instances Into Physical Areas of Coherence in Distributed Antenna Wireless Systems”

U.S. application Ser. No. 12/802,975, filed Jun. 16, 2010, entitled “System And Method For Link adaptation In DIDO Multicarrier Systems”

To reduce the size and complexity of the present patent application, the disclosure of the Related patents and applications is not explicitly set forth below. Please see the Related patents and applications for a full description of the disclosure.

In one embodiment the coverage area has multiple distributed antennas or base transceiver stations (“BTSs”) that are distributed around the coverage area, for example, an arena or stadium, such that some or all of the transmissions overlap in, around and within the areas occupied by humans, e.g., arena attendees for a live event. The transmissions of the distributed antennas are controlled so as to coordinate their transmissions such that, at any given time, constructive and destructive interference of the multiple waveforms results in a radiation pattern of sufficiently high power and duration in the air in between human bodies to inactivate viruses, but sufficiently low power where humans are located to be safe for human exposure, in accordance with applicable EM radiation human exposure guidelines, such as ICNIRP, FCC and IEEE guidelines [34-36],[43]. Technically, the infective form of a virus outside a host cell is defined as “virion”, and in this Application we use the word “virus” to refer to either a virus or a virion.

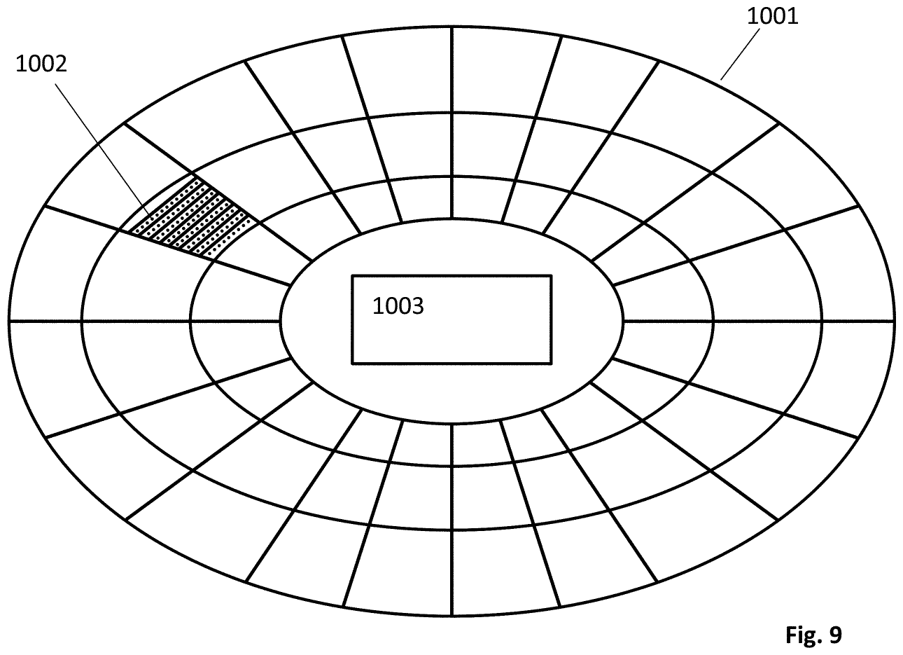

FIG. 9 shows a public space, in one embodiment an arena, stadium or theater 1001, with seating for attendees, e.g., on one or more sides of a field, ice rink, stage or other type of performance area 1003. Typically, the seats 1002 in such public spaces are angled to rise steadily upward from the performance area 1003 so as to allow attendees to see over the heads of people in front of them.

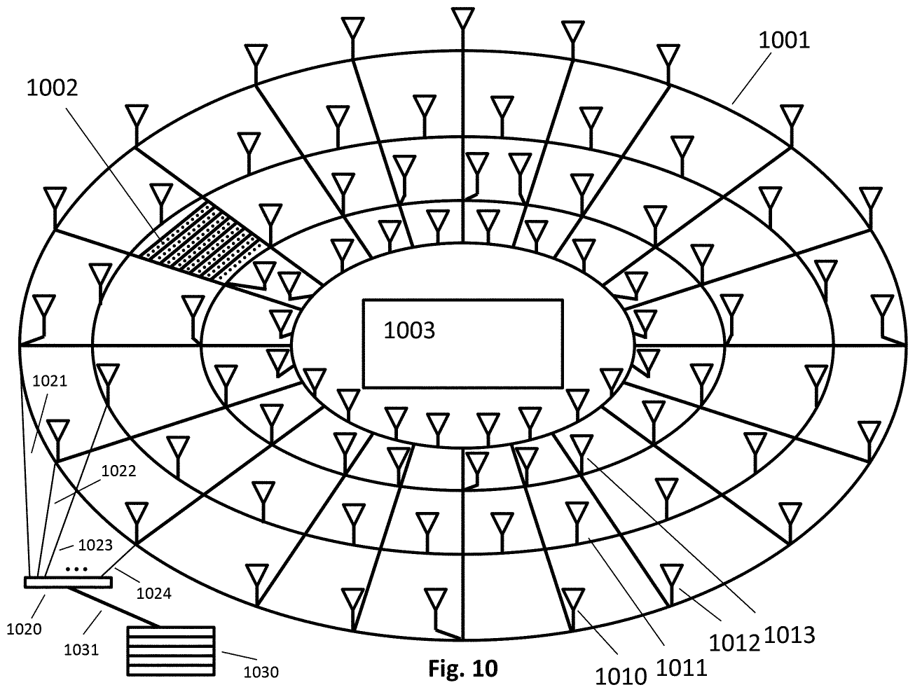

In one embodiment, antennas or BTSs are distributed throughout public space FIG. 9 as in FIG. 10. FIG. 10 shows 80 antenna or BTSs, labeling antennas or BTSs 1010, 1011, 1012 and 1013 as examples, but antennas or BTSs 1010-1013 shall mean all antennas or BTSs in the public space. Antennas or BTSs 1010-1013 can be standalone antennas that are not part of BTSs, or they can be BTSs with antennas. If the antennas or BTSs 1010-1013 are standalone antennas, then the radio frequency (RF) signal is provided to the antenna through a communications means including but not limited to a coaxial cable. If the antennas or BTSs 1010-1013 are BTSs, then the BTSs receive communications through a communications means including but not limited to optical or wired Ethernet, common public radio interface (CPRI), digital over cable service interface specification (DOCSIS), and/or wireless communications means or any combination thereof, or omnidirectional, directional, with one or more polarizations. The embodiment shown in FIG. 10 shows 80 antennas or BTSs 1010-1013. Other embodiments will have more or less antennas or BTSs 1010-1013.

The antennas or BTSs 1010-1013, whether standalone antennas or antennas on BTSs, can be antennas of any type, whether single antennas or antenna arrays, including but not limited to omnidirectional antennas, directional antennas of any gain, multi-lobe antennas, beam forming or beam steering active arrays, including phased array antennas with fixed or variable beam configurations, “Massive MIMO” antenna arrays, microwave horns, multi-spot beam antennas, parabolic or any reflector antennas, or any other type of antenna or antenna array designed for single band or multi-band applications.

The RF signal driving each antenna or each BTS 1010-1013, whether standalone antennas or antennas on a BTS, can be fixed frequency or variable frequency, fixed bandwidth or variable bandwidth, fixed power level or variable power level, linear or non-linear, and they can be of any frequency, bandwidth or power level. Some or all of the antennas or BTS antennas 1010-1013 may have the same or different frequencies, bandwidth, power, or linearity.

In the paragraphs below, “useful radiated power” for a given point means that the RF power received at that point is useful for the purposes of the intended application. In one embodiment, the transmission range of all of the antennas or BTSs 1010-1013 is sufficient to reach all points in the public space with useful radiated power. In another embodiment, the transmission range of some or all of the antennas or BTSs 1010-1013 does not reach all points in the public space with a useful radiated power. In one embodiment, the some or all points in the public space are reached by overlapping transmissions from one or more antennas or BTSs 1010-1013 with useful radiated power.

In one embodiment, a controller 1030 generates some or all of the baseband waveforms that are transmitted or received by some or all of the antennas or BTSs 1010-1013. The controller 1030 can be implemented in hardware in any form, including but not limited to application-specific integrated circuits (ASICs), field-programmable gate arrays (FPGAs), digital signal processors (DSPs), general-purpose central processing units (CPUs), or graphics processing units (GPUs), or in any combination thereof. In one embodiment, the baseband waveforms are transmitted over a communications means 1031 of any type, including but not limited to optical or wired Ethernet, common public radio interface (CPRI), digital over cable service interface specification (DOCSIS), and/or wireless communications means or any combination thereof. Communications means 1031 can be one or multiple physical or virtual communications means. Communications means 1031 may connect directly to the BTSs 1010-1013, or communications means 1031 may connect to one or more communications switches 1020 which then routes the communications from centralized controller 1030 to BTSs through communications means, of which 1021-1024, are shown as four examples, but communications means 1021-1024 shall mean all of the communications means between communications switches 1020 and BTSs 1010-1013. Communications means 1021-1024 can be any communications means including but not limited to any of the communications means listed above in this paragraph, and some or all may be the same communications means and some and all may be different communications means. Communications means 1021-1024 can include power for some or all of the BTSs through any means including but not limited to any version of power over Ethernet. In one embodiment the BTSs 1010-1013 are connected in a daisy chain of communications means that may or may not include power in the daisy chain.

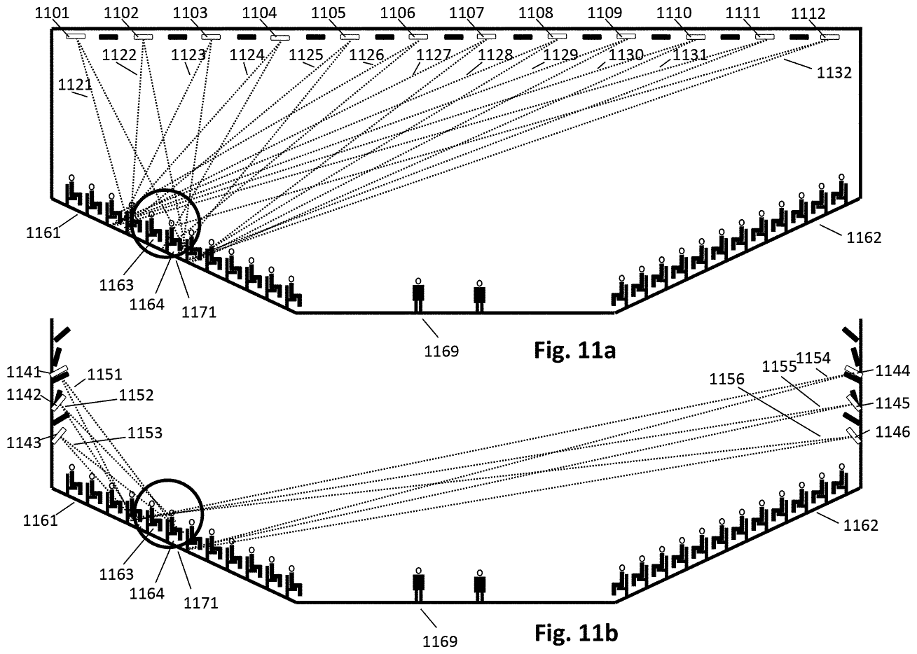

FIG. 11a shows an elevation view of a public space that is covered by a roof. FIG. 11b shows a similar elevation view a public space without a roof. FIGS. 11a and 11b show one row of seats 1161 and 1162 on each side of a central performance or game field area with two performers or players 1169. FIGS. 11a and 11b are illustrative and do not show depth or any details of the public spaces.

FIG. 11a shows an embodiment with 12 directional antennas with adaptive beam forming 1101-1112 (“Antennas 1101-1112”) on the ceiling as white rectangles. FIG. 11b shows an embodiment with 6 directional antennas with adaptive beam forming 1141-1146 (“Antennas 1141-1146”) on the walls as white rectangles. The Antennas 1101-1112 and Antennas 1141-1146 can be made from any prior art technology including but not limited to phased array antennas and Massive MIMO antenna arrays. In one embodiment Antennas 1101-1112 are standalone antennas and in one embodiment they are antennas for a BTS.

The quantity and arrangement of Antennas 1101-1112 and Antennas 1141-1146 shows one embodiment. In other embodiments, the quantity and arrangement varies to effectively any quantity of Antennas 1101-1112 and/or Antennas 1141-1146 arranged in any configuration or orientation. Such embodiments include but are not limited to have more or fewer Antennas 1101-1112 and Antennas 1141-1146; having them placed 1-, 2- and 3-dimensional arrangements; having them placed anywhere in the public space, including but not limited to on the ceiling, suspending from the ceiling or catwalks, above ceiling tiles, on walls, on the floor, on seats, on railings, on poles, on light poles, and on vehicles either permanently or temporarily. One embodiment of the quantity and arrangement of Antennas 1101-1112 and Antennas 1141-1146 is shown by BTSs 1010-1013 in FIG. 10 as the quantity arrangement of is an example of one embodiment.

Although not shown in FIGS. 11a and 11b, in one embodiment the Antennas 1101-1112 and Antennas 1141-1146 are communicatively coupled to one or more controllers 1030 as shown in FIG. 10 either directly or through one or more switches 1020. All of the embodiments contemplated for antennas or BTSs 1010-1013 are also contemplated for Antennas 1101-1112 and Antennas 1141-1146.

In one embodiment the beamforming functionality of the Antennas 1101-1112 is implemented locally, and in one embodiment the beamforming functionality is implemented remotely, and in one embodiment there is a mix of local and remote beamforming functionality. In one embodiment a controller, such as controller 1030, sends instructions to a processor means local to the Antennas to form beams. In one embodiment a controller, such as controller 1030, sends a plurality of waveforms to each of the Antennas 1101-1112 corresponding to the plurality of antennas in an array in each of Antennas 1101-1112 and those plurality of waveforms result in a desired beamforming transmission from each of Antennas 1101-1112. In one embodiment one or more of the Antennas 1101-1112 in configured with a fixed beamwidth using any prior art technique including but not limited to patch antennas, Yagi antennas, dish antennas, phased array antenna and Massive MIMO antenna arrays. In one embodiment one or more of the Antennas 1101-1112 is omnidirectional in one or more dimensions. In one embodiment one or more of the Antennas 1101-1112 are configured with one or more polarizations.

FIG. 11a shows an embodiment in which ceiling Antennas 1101-1112 transmit beams 1121-1132 such that the beams all reach the target area 1171. The shape of each beam is illustrated in 2 dimensions with dotted lines in a “V” shape, but the actual shape of each beam is 3 dimensional and has a more complex beam pattern. In one embodiment some or all of each of the Antennas 1101-1112 may emit more than one beam in more than one direction, wherein the more than one beam comprises multiple steerable beams, side lobes or grating lobes of the antenna array.

FIG. 11b shows an embodiment in which wall Antennas 1141-1146 transmit beams 1151-1156 such that the beams all reach target area 1171. The shape of each beam is illustrated in 2 dimensions with dotted lines in a “V” shape, but the actual shape of each beam is 3 dimensional and has a more complex beam pattern. In one embodiment some or all of each of the Antennas 1141-1146 may emit more than one beam in more than one direction, wherein the more than one beam comprises multiple steerable beams, side lobes or grating lobes of the antenna array.

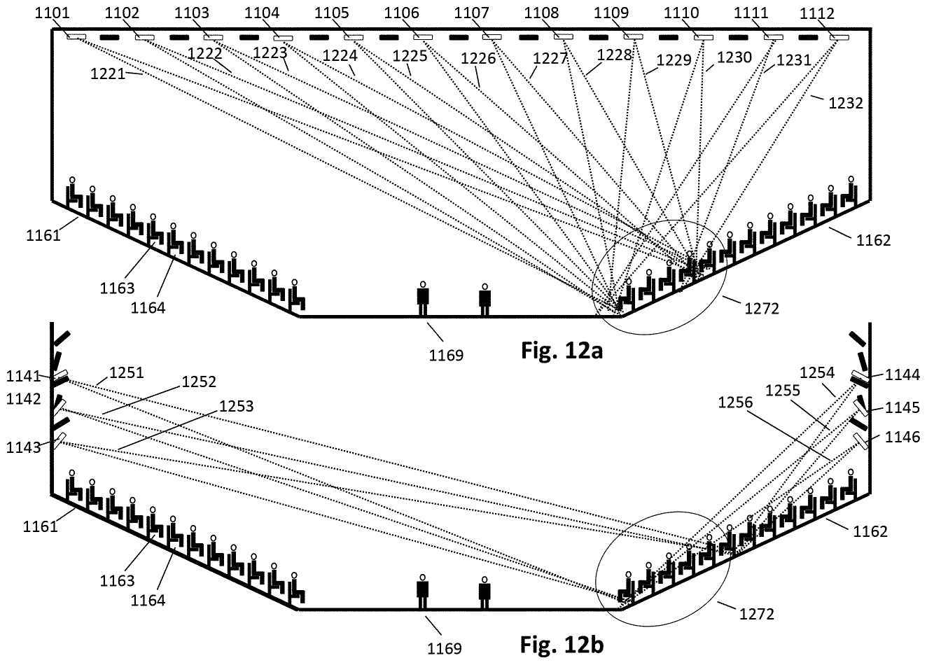

FIGS. 12a and 12b show the same public spaces as FIGS. 11a and 11b, but in these embodiments show the beams of Antennas 1101-1112 and Antennas 1141-1146 aimed to reach target 1272. Each of Antennas 1101-1112 and Antennas 1141-1146 can be configured to point to any target in the public space that is within the beamforming angle range and useful radiated power. The Antennas 1101-1112 and Antennas 1141-1146 can all point at the same target, some can point at different targets at once, and each antenna can transmit one or more beams to one or more targets. Changing the angle and/or aperture of each of the Antennas 1101-1112 and Antennas 1141-1146 can be very fast, potentially within nanoseconds or less, and the beams can either remain pointed at one target for a period of time before pointing at another target, or they can be continuously swept through part or all of the public space. In one embodiment, the beams point to only one target at a time. In a different embodiment, the beams point to multiple targets at the same time and/or within the same frequency band.

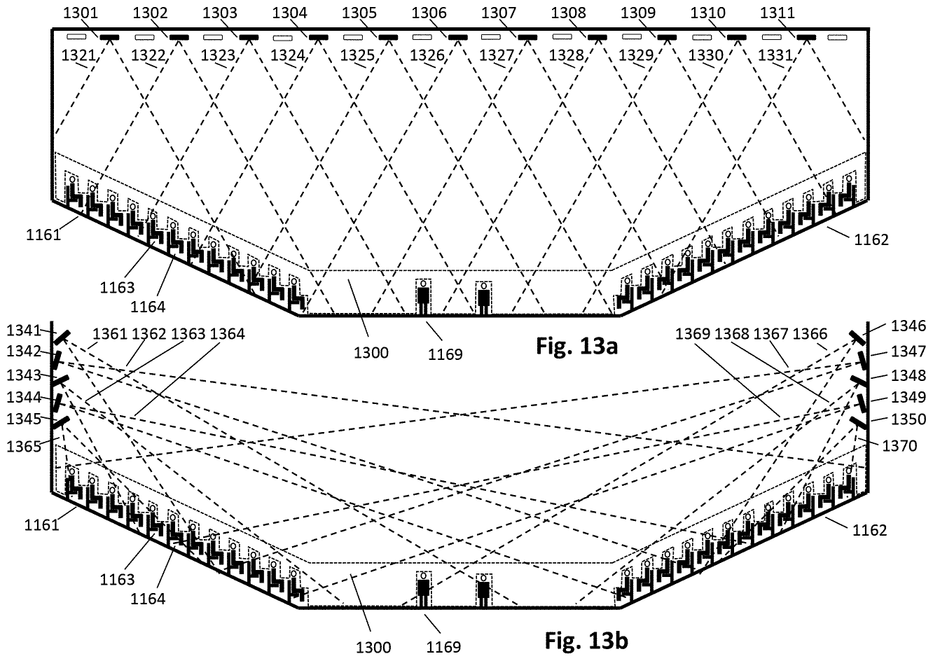

FIGS. 13a and 13b show the same public spaces as FIGS. 11a, 11b, 12a and 12b. FIGS. 13a and 13b show embodiments in which LIDAR units 1301-1311 and 1341-1350, shown as black rectangles, are used to determine where in the public space humans and/or other objects are located. In one embodiment the LIDAR units 1301-1311 and 1341-1350 have overlapping scan windows 1321-1331 and 1361-1370 which individually or together provide a 3-dimensional topological map of the areas of the public space occupied by people. From this topological map a 3 dimensional “inactivation” volume 1300 around humans and/or other objects is determined. An elevation view of one embodiment of an inactivation volume 1300 is illustrated in FIGS. 13a and 13b as a region within a dashed line. Each LIDAR unit 1301-1311 and 1341-1350 can determine the distance from the LIDAR unit to points within its Field of View and Depth to a given precision, depending on their LIDAR unit. For example, Intel® Real Sense™ LIDAR Camera L515 has a range of 9 meters with a Field of View of 70°×55° with an x, y resolution of roughly 15-20 mm at 9 meters, and depth (z) resolution of roughly 15.5 millimeters at 9 meters, operating at 30 scans per second with a “photon latency” (delay between LIDAR measurement and output of that measurement) of 4 milliseconds (msec). Thus, at a distance of 9 meters, such a LIDAR unit can be used to determine a 3D inactivation volume 1300 within about 20 mm×15 mm×15.5 mm in x, y, z. (For a longer distance than 9m, a different LIDAR unit would be used with specifications suited for a longer distance.)

The inactivation volume 1300 is a region in space with high enough RF power density to inactivate some or all viruses in aerosol form within the inactivation volume 1300. Since infected humans often release viruses in aerosol form from their mouths and noses after a violent expiratory event (e.g. a cough or sneeze) or when talking, and humans also are often infected by viruses in aerosol form through their eyes, nose, or mouth, it is important that the inactivation volume 1300 is near to the head of humans in the public space such that viruses in aerosol form are inactivated whether they emanate from infected humans or emanate from another source and might come in contact with humans, particularly with the eyes, nose and mouth (all located in the head) where the virus can infect the body. Essentially, the inactivation volume 1300 acts an invisible “virus shield” around humans, particularly around human heads. However, RF power density that is high enough to inactivate viruses may be higher than the recommended guidelines (e.g., FCC, ICNIRP and IEEE), for maximum RF power density for human exposure, thus while it is important for the inactivation volume 1300 to be near the head of humans in the public space, it is also important that the inactivation volume does not overlap with any part of the human body. To accomplish this, given LIDAR resolution, the inactivation volume 1300 must be far enough away from any part of the human body to take into account the 3D resolution (including any measurement error) of the LIDAR, the scan and photon latency of the LIDAR, and the speed a human can move. For example, in the case of the Intel LIDAR Camera L515, the gap (called the “safety gap” herein) between the inactivation volume 1300 and any part of the human body must be more than the LIDAR Camera L515's resolution, which at 9 m of distance from the point of measurement is roughly 20 mm×15 mm×15.5 mm in x, y, z. Further, to allow for the fact the human body may move, the safety gap must be large enough such that, given the fastest speed at which a human can move, no part of the human body will penetrate the shape of the inactivation volume 1300 before the LIDAR rescans the area to determine a new shape for the inactivation volume 1300 that continues to have a safety gap between it and any part of the human body.

The LIDAR Camera L515 has scan rate of 30 scans per second and a photon latency of 4 msec, thus the camera measures a given point 30 times a second, or every 33.3 msec, and it adds a delay of 4 msec before it outputs each measurement, resulting in a total latency of 33.3+4=37.3 msec before the motion of a previously measured point can be detected. Depending on the situation, the human body can traverse different amounts of distance in 37.3 msec. As an example of very limited speed of motion, a person seated or standing within rows of seats surrounded by other spectators, motion of the torso, head and legs, is quite limited in motion and will not traverse very much distance at all in 37.3 msec, and the safety gap can be quite small, on the order of a few centimeters (cm). As an example of very fast motion, a hockey player skating in a game might reach a speed of 32 kilometers per hour (kph) which would traverse roughly 33 cm (about 1 foot) of distance in 37.3 msec, requiring a safety gap of at least 1 foot. Another extreme example is the distance traversed by a hand when pitching a baseball, which can reach speeds of just over 100 miles per hour (161 kph) when the baseball is released. At such speed, the hand would traverse 1.7 m (5.6 feet) in 37.3 msec. However, a pitcher's hand accelerates up to that speed just for the moment of release of the ball and is traveling at slower speed both before and after release, and thus the average speed of the hand in a 37.3 msec interval is less than 161 kph, with distance traversed by the hand less than 1.7 m. Still, a pitcher's hand would traverse a significant distance in 37.3 msec, and thus would require an appropriately larger safety gap or a LIDAR system with a shorter scan and photon latency. In one embodiment, different size safety gaps are established for different regions of public spaces in accordance with the maximum speed of the humans in that region. For example, humans in the stands 1163-1164 would have relatively low maximum speed and relatively smaller safety gap. An athlete 1169 such as a hockey player on the ice would have a relatively higher maximum speed and relatively larger safety gap. An athlete 1169 that is a pitcher on a baseball mound would have an even higher maximum speed and larger safety gap. In another embodiment, LIDAR with faster scan and lower photon latency is used for regions with humans with faster motion to enable a small safety gap despite the faster motion.

In another embodiment, the speed of humans in the public space is dynamically determined by the LIDAR comparing x, y, z measurements of successive scans (e.g. detecting that a volume of space previously measured as containing a solid object is measured in one or more successive scans as no longer containing a solid object, and determining what velocity would have to be reached for a solid object of that size to move from the previously non-empty space) and adjusting the safety gap accordingly given that velocity. In one embodiment, the velocity is measured in successive scans to estimate the acceleration curve, and from this acceleration curve the future velocity during the next scan time is estimated, and the safety gap is adjusted for the duration of that scan time accordingly given that future velocity. In one embodiment the dynamic safety gap estimate just described can be applied to just the region of space where the motion is detected. In another embodiment, the dynamic safety gap estimate just described is applied to a region of space along the measured path of motion. As an example, while a pitcher's hand moves rapidly in a specific path of motion during a pitch or when throwing or catching a ball, the hand moves very slowly when the pitcher is standing in preparation for the pitch, and even when the ball is pitched, other parts of the pitcher's body, the head in particular, moves much slower than the hand. Thus, by dynamically adjusting the safety gap based on the region of space measured and only increasing the safety gap in the path of motion, when a pitcher is not pitching, the safety gap can be quite small around their entire body, and during the pitch, the safety gap need only be made much larger in the path of motion of the hand, which is generally a primarily linear path throwing the ball toward home plate, and the safety gap around other parts of the body, such as the head is only as large as is required for the slower head motion. If the case of a hockey player, the entire body would be detected as moving at a fast speed in the direction of the skating, being it forward or backward skating. Such velocity and acceleration would be measured as detailed above, and the safety gap would be made larger in the direction of motion at the estimated future velocity. If the hockey player stopped moving, the velocity would be detected to be near zero, and the safety gap would dynamically become smaller. In one embodiment, computer vision, artificial intelligence (AI) or machine learning (ML) methods are employed to detect the contour of the human bodies (e.g., players, performers or fans in the arena), estimate the boundaries of the safety gap and/or the inactivation volume.

In a different embodiment, the units 1301-1311 and 1341-1350 in FIGS. 13a and 13b are radar systems using RF to detect the presence of human bodies or other objects in the public space. In one embodiment, the radar system comprises high-frequency imaging radar using terahertz frequencies [39], or millimeter and submillimeter waves [40],[41]. High-frequency imaging radar equipment can provide good accuracy (e.g., TSA airport scanners) as human bodies act as RF scatterers at those frequencies, but typically it is operated only at short distances and is expensive and bulky. In another embodiment, the radar system comprises centimeter waves or sub-10 GHz frequencies [42]. Since at these frequencies the human body acts as a reflector rather than a scatterer, sub-10 GHz radar provides only limited scanning resolution and requires the target person to move (while with a static background), so that the body contour is reconstructed by combining multiple reflections off of different human limbs over time. In one exemplary embodiment, sub-10 GHz radar is used in arenas or Olympic stadiums to detect the contour of the players or athletes during the games.

In another embodiment, the units 1301-1311 and 1341-1350 in FIGS. 13a and 13b are cameras or thermal imaging cameras. One advantage of cameras is their high-resolution imaging, but they are limited by light exposure and possible agents like smoke or fog that may obstruct the view of the target (e.g., during concerts in arenas). In one exemplary embodiment, cameras are used in outdoor arenas during daylight or indoor arenas with high enough level of light exposure. Thermal imaging cameras provide good contour detection when the human body produces enough heat to transfer it through its clothes or the skin is directly exposed to the camera. In another exemplary embodiment, thermal imaging cameras are used to detect the contour of athletes or players in action during a game or people with exposed skin in swimming pools.

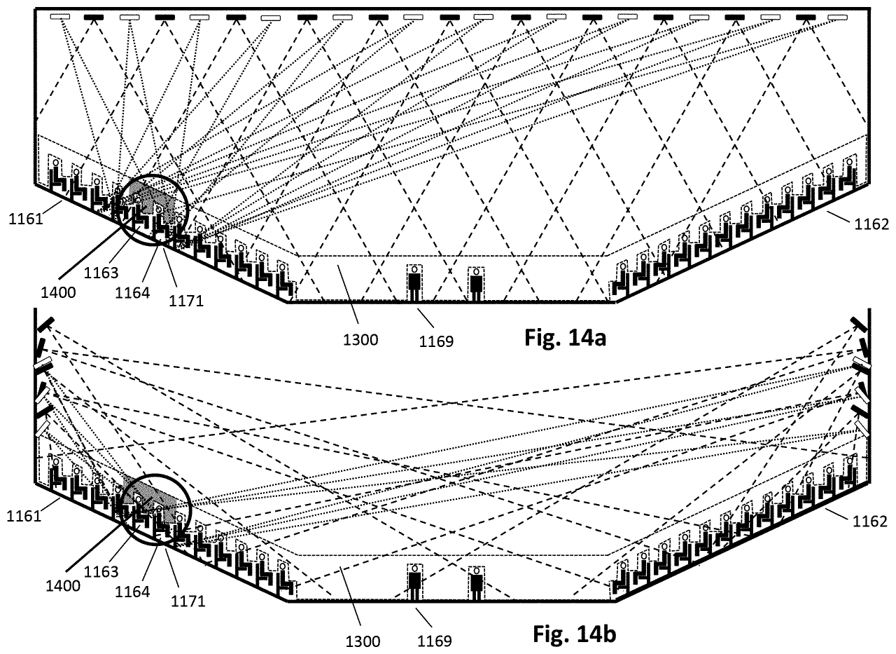

FIGS. 14a and 14b show the elements of FIGS. 11a, 11b, 13a and 13b combined. FIG. 14a shows the transmit beams 1121-1132 from ceiling Antennas 1101-1112 reaching target area 1171, and FIG. 14b shows the transmit beams 1151-1156 from wall Antennas 1141-1146 reaching target area 1171. FIGS. 14a and 14b also shows the inactivation volume 1300 that surrounds the humans in seats 1161 and 1162 as well as athletes or performers 1169 that is determined by a 3D topological map determined by overlapping scans from ceiling LIDAR units 1301-1311 or wall LIDAR units 1341-1350. FIGS. 14a and 14b show a shaded subset 1400 of the inactivation volume 1300 that is within target area 1171 and partially surrounds humans 1163 and 1164. Inactivation volume subset 1400 is discussed in the following paragraphs and figures.

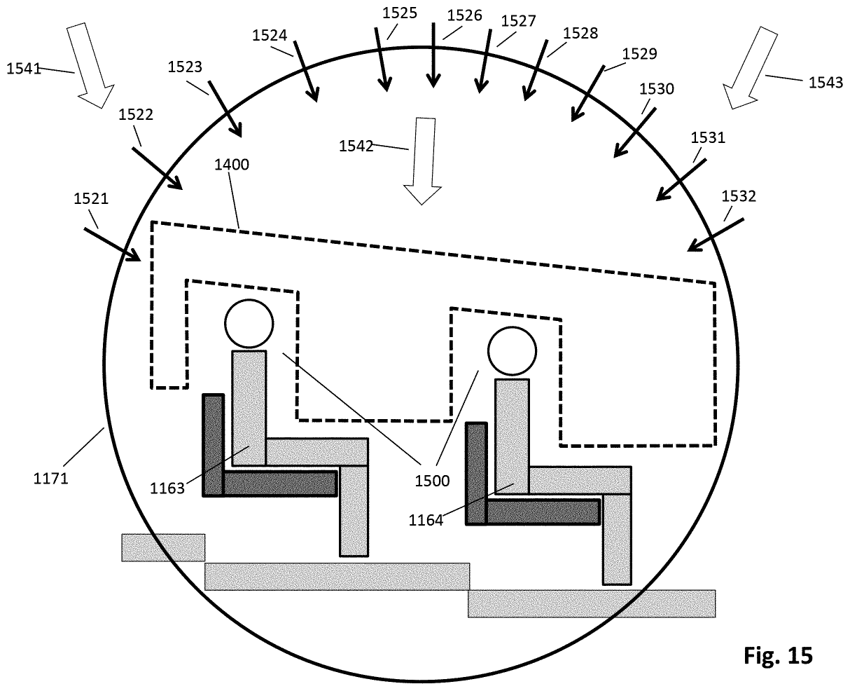

FIG. 15 shows a detailed view of inactivation volume 1400 (shown in a dashed outline) within target area 1171 over humans 1163 and 1164. Vectors 1521-1532 show the direction of incoming transmit beams 1121-1132 (shown in FIG. 11a) that reach target area 1171. Wide arrows 1541-1543 show the direction of incoming LIDAR overlapping scan windows 1321-1323 (shown in FIG. 13a) that overlap target area 1171. There is a safety gap 1500 between the humans and the inactivation volume subset 1400. As described above in one embodiment the safety gap is generally kept small so that the inactivation volume 1400 will be close to the humans, particularly their heads. The size of the safety gap 1500 is determined by the volume occupied by humans, the resolution of the LIDAR, and the velocity that the humans may move relative to LIDAR scan and photon latency to be sure that no body parts of the humans enter the inactivation volume.

Note that in the embodiment shown in FIG. 15 the inactivation volume 1400 does not extend below the torso of the seated humans 1163 and 1164 to illustrate how the inactivation volume 1400 can be limited in size and still be effective for virus inactivation. In this embodiment the inactivation volume 1400 is behind, above, in front and below the heads of humans 1163 and 1164, covering most of the regions that airborne viruses would leave a human body in a cough or sneeze, or would enter a human body through eyes, nose and mouth. While other embodiments can have an inactivation volume 1400, the more limited inactivation volume 1400 of the embodiment shown in FIG. 15 would be less expensive to implement. LIDAR scans are limited by obstructions, and unless a LIDAR unit is directly above a row between seats (e.g. as is shown with LIDAR wide arrow 1542), its scan will be blocked to some degree by the seats and the humans 1163 and 1164. But even that will not allow the LIDAR scan to reach the below the seats to scan the volume behind the feet of the humans 1163 and 1164. Also, when high frequencies (e.g., >6 GHz) are transmitted by the Antennas 1101-1112 and Antennas 1141-1146, they may not be able to penetrate objects, such as humans 1163 and 1164 and the seats, limiting their ability to create a high RF power density in the inactivation volume 1400. But, if an inactivation volume 1400 is required in an obstructed area, then LIDAR and Antennas can be installed in locations (e.g. behind the seats, in the floor, etc.) which can reach the obstructed area.

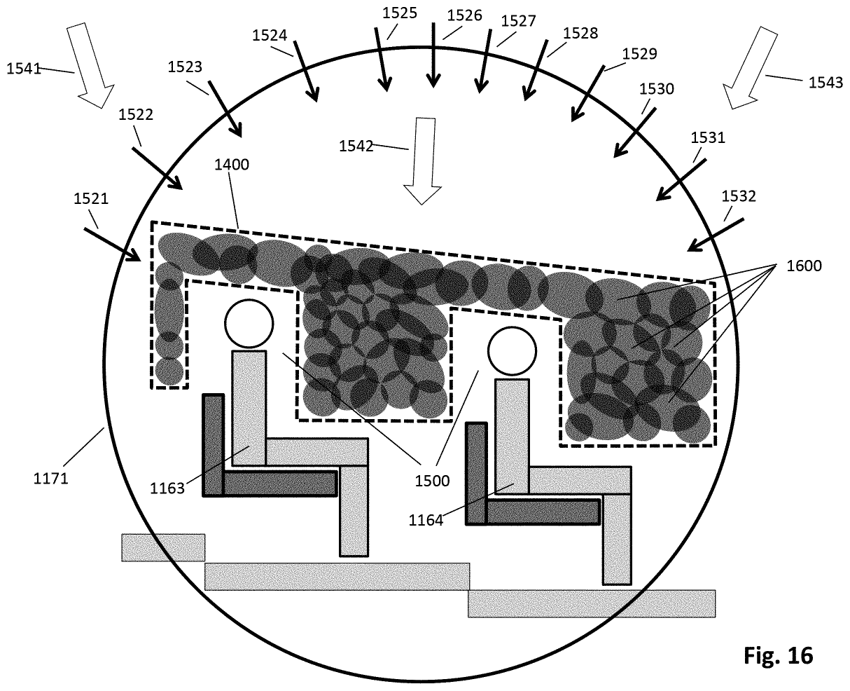

FIG. 16 shows the same elements of FIG. 15, but also shows “volumes of coherence” 1600, which are shown as shaded gray shapes of various sizes and shapes within the inactivation volume 1400. The volumes of coherence” 1600 are volumes in space wherein the signals received from the incoming transmit beams 1121-1132 (arriving from the directions of vectors 1521-1532) add up coherently by steering the transmit beams 1121-1132 to the same physical location and/or by utilizing precoding methods such as beamforming, maximum ratio transmission or pCell precoding disclosed in the Related patents and applications. While there are only four lines labeling gray shapes with 1600, as used herein, “volumes [in plural] of coherence” 1600 refers to all of the gray shapes within the inactivation volume 1400 and “volume [in singular] of coherence” 1600 refers to one of the gray shapes within the inactivation volume 1400. Although this illustration shows each volume of coherence 1600 as a 2D area, each volume of coherence 1600 is 3D volume in space that delineates where the resulting power density from the overlap of transmit beams 1121-1132 (arriving from the directions of vectors 1521-1532) is at least as high as the “inactivation power density”.

The “inactivation power density” as used herein is the minimum RF power density level at a given frequency required to inactivate the targeted airborne virus in the inactivation volume 1400 for the time interval of the “dwell time”. The “dwell time” as used herein is the duration of the interval of time where the RF power density at the inactivation power density must be applied to a virus in the inactivation volume 1400 for it to be inactivated. For example, if virus inactivation requires a power density of 1000 W/m² at 8 GHz for 1 msec, then inactivation power density is 1000 W/m², and the dwell time is 1 msec.

In one embodiment, the Antennas 1101-1112 transmit beams 1221-1232 that overlap to result in one volume of coherence 1600 in inactivation volume 1400 with at least the inactivation power density and continue that transmission for the time interval of the dwell time. Then, the Antennas 1101-1112 transmit different beams 1221-1232 that overlap to result in a different volume of coherence 1600 in inactivation volume 1400 with at least the inactivation power density and continue that transmission for the duration of the time interval of the dwell time. The Antennas 1101-1112 repeat this for one volume of coherence 1600 in inactivation volume 1400 after another, until almost the entire volume of inactivation 1400 has been reached by volumes of coherence 1600. Because the volumes of coherence 1600 are unlikely to be shapes that can exactly fit within the geometric shape of the inactivation volume 1400, the successive volumes of coherence 1600 are unlikely to exactly fill the inactivation volume 1400, but rather will come close to its edges, as illustrated in FIG. 16. In one embodiment, after almost the entire inactivation volume 1400 has been reached by successive volumes of coherence 1600, then the Antennas 1101-1112 repeat again the process described above to reach almost the entire inactivation volume 1400 by volumes of coherence 1600. Each such cycle of reaching almost the entire inactivation volume 1400 by volumes of coherence 1600 is called herein a “sweep cycle”. In a different embodiment, multiple volumes of coherence are created by some or all the antennas 1101-1112 or different subsets of antennas at the same time and/or within the same or different frequency bands. In another embodiment of the invention, the system dynamically adjusts the shape and size of the volumes of coherence as it sweeps its beams through the inactivation volume 1400.

As noted previously, the inactivation volume 1400 is likely to change as humans move through the public space. As the inactivation volume 1400 changes, the Antennas 1101-1112 will adaptively adjust the direction of the beams that intersect to form the volumes of coherence 1600 such that they stay within the bounds of the inactivation volume 1400, both for the last measured inactivation volume 1400 and for an estimated inactivation volume 1400 based on measured motion or acceleration of objects in the public space or based on any other criteria that changes the inactivation volume 1400. Antennas 1101-1112 transmit beams 1221-1232 that overlap to result in volumes of coherence 1600 that almost reach the entire inactivation volume 1400 with at least the inactivation power density and dwell time to inactivate the viruses in the inactivation volume 1400.

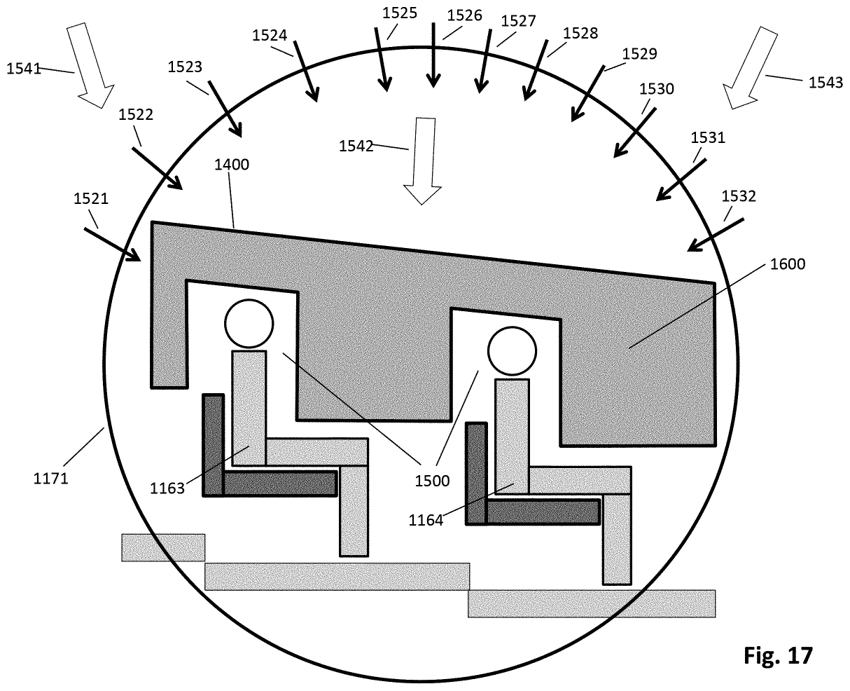

FIG. 17 is the same as FIG. 16, but the volumes of coherence 1600 are illustrated as a solid area of gray rather than as separate overlapping shapes.

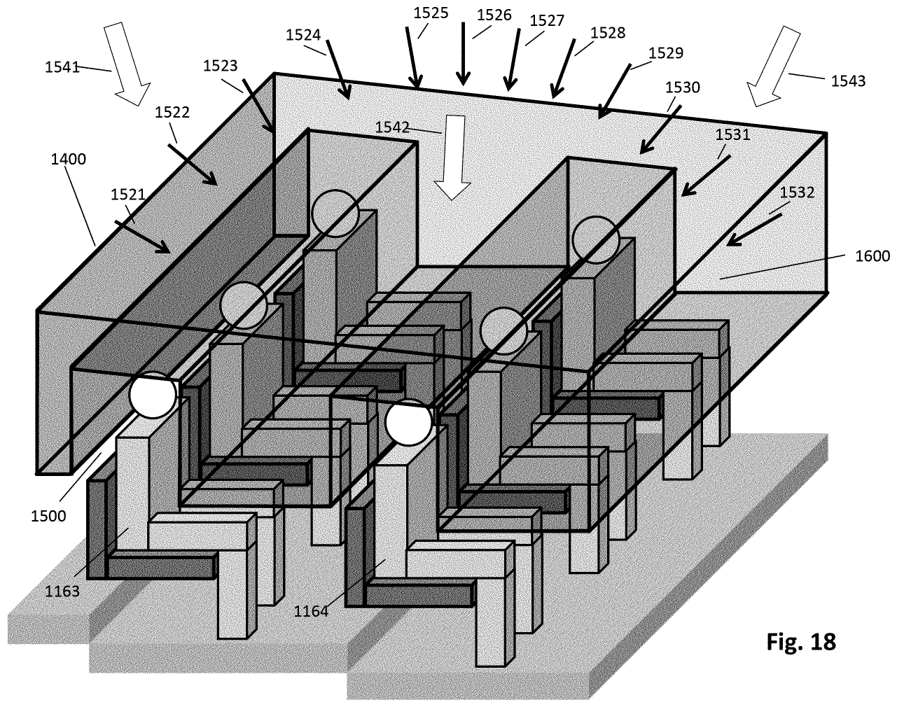

FIG. 18 shows the same embodiment as FIG. 17, except it is shown as an orthogonal 3D illustration with 3 humans sitting in each of the 2 rows. In this embodiment the inactivation volume 1400 is shown to be behind, above and in front of each of the humans, including humans 1163 and 1164, with a safety gap 1500 between the inactivation volume 1400 and the humans. The LIDAR units 1301-1303 repeatedly scan from directions 1541-1543 and continually update the shape of inactivation volume 1400 to allow for motion and acceleration of the humans, and the Antennas 1101-1112 transmit beams 1221-1232 in the direction of vectors 1521-2532 that overlap to result in volumes of coherence 1600 that almost reaches the entire inactivation volume 1400 each sweep cycle. This entire process repeats continuously in successive sweep cycles so that the airborne viruses in the inactivation volume are continuously inactivated.

FIG. 18 does not show the inactivation volume 1400 as extending between humans sitting in the same row for the sake of keeping the 3D illustration easy to understand, but in many embodiments the inactivation volume 1400 would extend between people sitting next to each other to inactivate virus transmissions between the people sitting next to each other.

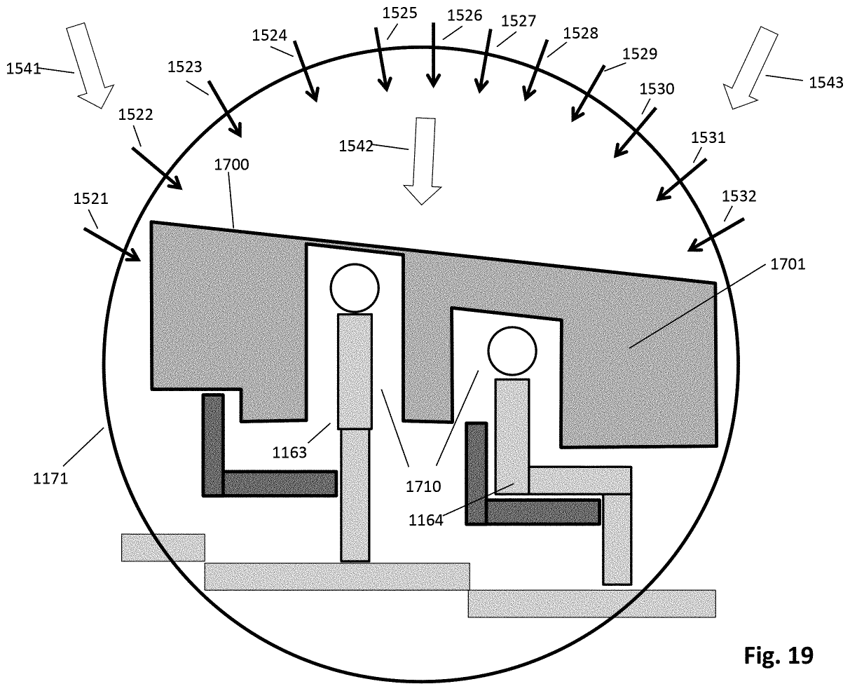

FIG. 19 is a 2D illustration that shows the same embodiment as FIGS. 17 and 18 except that it shows human 1163 standing up, which is measured by LIDAR units 1301-1303 which results in reshaping inactivation volume 1400 to be the shape of inactivation volume 1700, with safety gap 1710 around the humans. Antennas 1101-1112 transmit beams 1221-1232 that overlap to result in volumes of coherence 1600 that almost reaches the entire inactivation volume 1400 each sweep cycle.

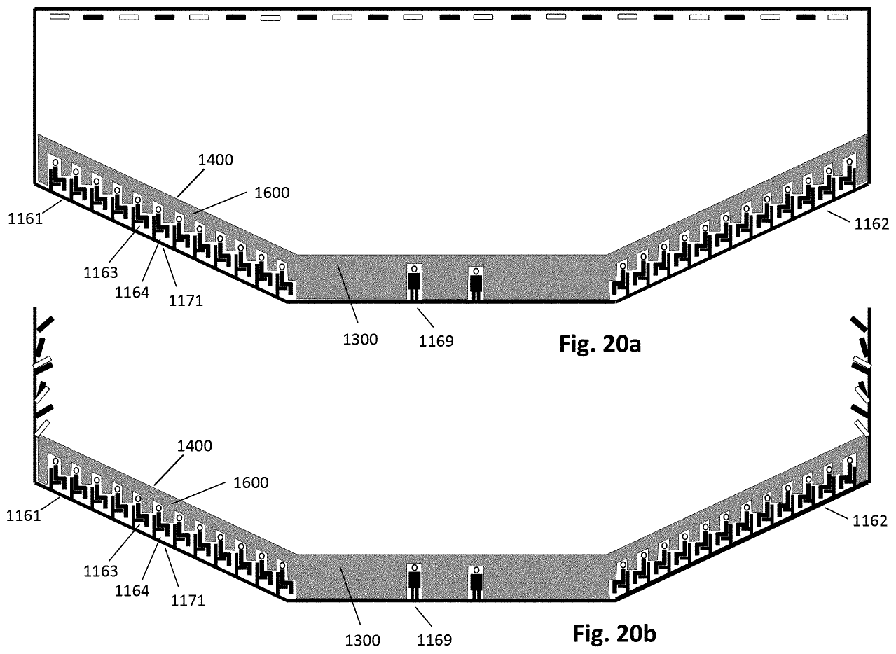

FIGS. 20a and 20b show the public space shown in FIGS. 11a, 11b, 12a, 12b, 13a, 13b, 14a, and 14b with the entire inactivation volume 1400 shaded in gray resulting from repeated sweep cycles of volumes of coherence 1400 reaching almost the entire inactivation volume 1400. As detailed above, the inactivation volume 1400 is a 3D volume and it continuously changes shape as humans move, while always maintaining a safety gap. Thus, airborne viruses are inactivated after they leave the bodies of infected humans and before they can enter the bodies of other humans in the public space.

In one embodiment the entire public space has one controller 1030. In another embodiment the public space has multiple controllers 1030. In another embodiment one or more BTSs among Antennas 1101-1112 and Antennas 1141-1146 have a controller 1030 that is built into the BTS that controls one or more BTSs. In another embodiment the some BTSs have a controller 1030 that is built into the BTSs and some have a controller that is not.

In one embodiment, a given radiation pattern created by the system would cover some of the regions of air in between humans, and the system would cycle through multiple radiation patterns to cover different regions of air in between humans, stopping with a radiation pattern at each location for a long enough time to inactivate the viruses in that location.

In another embodiment, the system simultaneously creates multiple radiation patterns at multiple resonant frequencies. In one embodiment, the multiple resonant frequencies are multiple resonant frequencies of the same virus. In another embodiment, the multiple resonant frequencies are one or more resonant frequencies of one or more than one virus. In another embodiment, the multiple resonant frequencies are multiple sub-bands that are near enough to the center resonant frequency or frequencies of a virus, with the radiation pattern of each sub-band inactivating viruses between humans at different locations in the public space.

One embodiment of this invention is to destroy viral capsids through either mechanical or EM resonances in a large area by electronically sweeping through a series of spatial patterns of EM radiation resulting from the overlapping waveforms of multiple transmit antennas. For example, one embodiment of the invention comprises one antenna array installed at the catwalks or ceiling of a stadium. Then, the system sweeps the beams created by the array downward toward the seating areas occupied by attendees during events that are exposed to viruses. In another embodiment, multiple antenna arrays are placed at different locations throughout the stadium in closer proximity to the seating areas and sweep through different sets of beams to different areas in different directions.

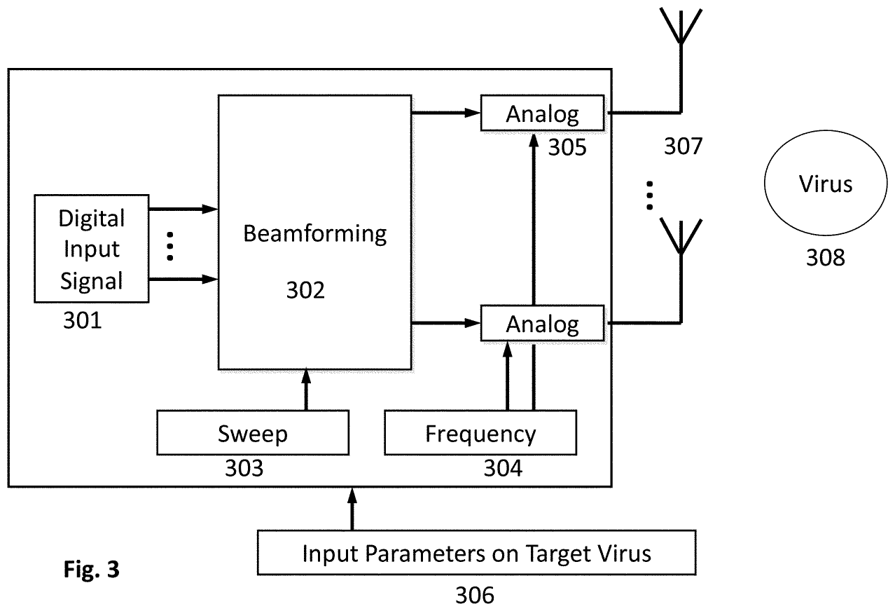

There are several components in the system disclosed in FIG. 3. The digital input signal unit 301 represents the baseband waveform that is beamformed, amplified, upconverted, and sent to the plurality of transmit antennas. The beamforming unit 302 applies a precoding function to the input signal to produce a certain transmit beam pattern. The precoding function varies over time, as controlled by the sweep unit 303 to ensure that a large area is covered. The frequency unit 304 drives the analog front end units 305 of the system to transmit a signal at a prescribed carrier frequency, as determined by the input parameter unit 306. The analog front end includes several functions including digital-to-analog conversion, upconversion, and filtering. The input into the system is one of several input parameters on the target virus or viruses of interest 308 (e.g., resonant frequency, location, dwell time, etc.). The output of the analog units is sent to the respective antennas or antenna arrays 307.

In one embodiment, the system implements a type of distributed antenna or BTS spatial processing commercially known as pCell® wireless technology (also called “Distributed-Input Distributed-Output” or “DIDO” wireless technology) as taught in the Related patents and applications. In some pCell embodiments, many of which are described in the Related patents and applications, pCell is used as a communication and wireless power transmission technology where the precoding is determined based on open- or closed-loop feedback from a plurality of user equipment (“UE”) devices. In another embodiment, pCell wireless technology is used with no UEs and no feedback from a UE. Instead of using UE feedback as input to precoding matrices, the input to the precoding matrices is determined the 3D shape of the inactivation volume 1400, as it changes shape over time, such that volumes of coherence 1600 are created and swept through the inactivation volume 1400. In another embodiment the input to the precoding matrices are swept over a manifold of possible values or using codebooks to vary the focal points of the beams throughout the coverage area over time.

One application of this embodiment is to inactivate viruses throughout the public space when no humans are there and there is no need to avoid them. This can be used, for example, in a public space after an event (e.g. a sports game or concert) once all of the attendees have left and no stadium staff is in the public space. This will have the effect of inactivating virions in all the locations that an RF pattern reaches that meets the inactivation power density including but not limited to surfaces in the public space, such a seats, floors, walls, and also objects that are impractical to reach for daily cleaning such as overhead rigging. Further, by means of scattering, areas that are not in line of sight view of the Antennas 1101-1112 and Antennas 1141-1146, such as the floor underneath seats potentially can be reached. Thus, after this manifold sweep is complete, the public space will have been subject to a thorough deactivation of any viruses still remaining in the space after attendees have left.

In one embodiment the beamforming unit 302 in FIG. 3 applies a precoding function to the digital input signals. In one embodiment, the beamforming block implements co-phasing, or maximum ratio transmission (MRT), or it adjusts phase and/or amplitude of the input signals 301 based on direction-of-arrival/departure (DOA/DOD) information, or it uses super-resolution techniques to estimate the DOA (e.g., MUSIC methods). In yet another embodiment, the beamforming block implements pCell processing as taught in the Related patents and applications.

The sweep unit 303 provides the coefficients for the beamforming block. Specifically, it periodically updates the beamforming coefficients to adjust the direction of the beams. In one embodiment, the beamforming coefficients change periodically, with the time interval during which the beam is fixed, referred to herein as “dwell time”. In another embodiment, the beamforming coefficients change more frequently to adjust the direction of the beams, so that the transmitted beams move faster. In one embodiment, the transmitted beams are adjusted so that their focus points are substantially different from dwell time to dwell time. One reason for this would be to disperse the energy so that larger objects, like human bodies, undergo lower aggregate exposure.

The digital input 301 into the system consists of a plurality of transmit signals. In one embodiment, the input signals are discrete-time sinusoids. In another embodiment they are digital communication signals. In yet another embodiment, they are chirp signals.

The analog front end units 305 implement all of the processing to modulate the signal for transmission on the target carrier frequency (e.g., corresponding to the resonant frequency of the virus). In one embodiment, this includes a digital-to-analog conversion, reconstruction filter, super heterodyne upconversion, filter, and power amplifier. In another embodiment, the analog units 305 and beamforming unit 302 are combined together, the beamforming being performed entirely in the analog domain.

The input into the system 306 is one of several input parameters on the target virus or viruses of interest. This could include the target virus' or viruses' mechanical or EM resonance frequency or frequencies as well as other system specific quantities like the dwell time, which in one embodiment would be the time that a beam must remain in one configuration to effectively inactivate a certain virus or viruses given certain environmental conditions (e.g., temperature, humidity).

To provide a more concrete description, one embodiment based on pCell processing is explained mathematically as follows: Let Nt denote the number of transmit antennas. Let Ns denote the number of digital input signals. This embodiment considers narrowband digital beamforming. Using well-known techniques in the art, for example MRT, this can be extended to broadband beamforming using space-time beamforming or orthogonal frequency division multiplexing modulation. Similarly, it will be clear how to implement the transmission process entirely in the analog domain: Let Tₛ denote the sample time, let T denote the dwell time, and let f_{c} denote the carrier frequency. The input to the digital beamformer is a vector s[n]=[s₁[n], s₂[n], . . . , s_{Ns}[n]]^{T}. The transmit precoding operation performed by the digital beamforming can be given by a precoding matrix F[n], which has dimension Nt×Ns. The digital signal input to the digital-to-analog converter is the product F*s[n]. The digital-to-analog converter (assuming perfect reconstruction) creates a continuous-time signal input to the k^{th} transmit antenna

$${x}_{k} ( t ) = {\sum }_{n} {x}_{k} [ n ] g ( t - n {T}_{s} )$$

where g(t) is a pulse shaping filter, specifically a sinc function with single sided bandwidth ½Tₛ. The signal on each antenna is then upconverted and amplified by the analog processing to create the signal sent on the k^{th} antenna

zₖ(t)=ARe{xₖ(t)} cos(2πf_{c}t)−AIm{xₖ(t)}sin(2πf_{c}t)

where A represents the amplification factor and Re{ } denotes the real part of the argument and In{ } denotes the imaginary part.

A key feature of this invention is that the precoding matrix is varied over time. When varied slowly, F[n] is constant during T observations and then changes. In a preferred embodiment, the variation of F[n] is described as follows:

F[n]=U[n]D[n]

where U[n] is a Nt=Ns matrix with unit norm and orthogonal columns and D[n] is a Ns×Ns diagonal matrix. The columns of U[n] are known as orthogonal beamforming vectors. The diagonal entries of D[n] indicate the power allocated to each beam. The collection of all possible matrices with unit norm and orthogonal columns of dimension Nt×Ns where Nt≥Ns is known as the Steifel manifold in mathematics literature. The Steifel manifold can be parameterized in several different ways, for example using Givens rotations or through Householder reflections. In each of these cases it is possible to construct a U[n] from a sequence of parameters {p[k,n]}ₖ. In this invention the set of parameters is quantized to produce a sequence of quantized parameters {{p[k,n]}} which are used to drive the precoding matrix construction. Similarly, the set of possible power allocations in D[n] can also be quantized.

In another embodiment, the variation of F[n] is described as follows.

F[n]=U[n]D[n]V[n]

where U[n] is a Nt=Ns matrix with unit norm and orthogonal columns, D[n] is a Ns×Ns diagonal matrix, and V[n] is a Ns×Ns unitary matrix. Compared with the previous embodiment, V[n] serves to further rotate the input signal before beamforming. This is especially useful when the input signal is relatively simple, for example a discrete sinusoid. The Steifel manifold characterization can also be used to parameterize V[n] and thus this sequence can be input to modify the beamforming vectors.

It should be noted that while FIG. 3 illustrates a pCell system using distributed BTSs with antennas (implying an EM transmission) the same signal processing steps could be applied in a system exploiting an ultrasonic or hypersonic transducer. In this case an acoustic wave instead of an EM wave would be transmitted but the other aspects of the invention remain the same.

In another embodiment of the invention, viruses are inactivated by impulsive stimulated Raman scattering (ISRS) using femtosecond lasers, cfr. [4] and [37]. In other embodiments of the invention other types of lasers are used for inactivating viruses.

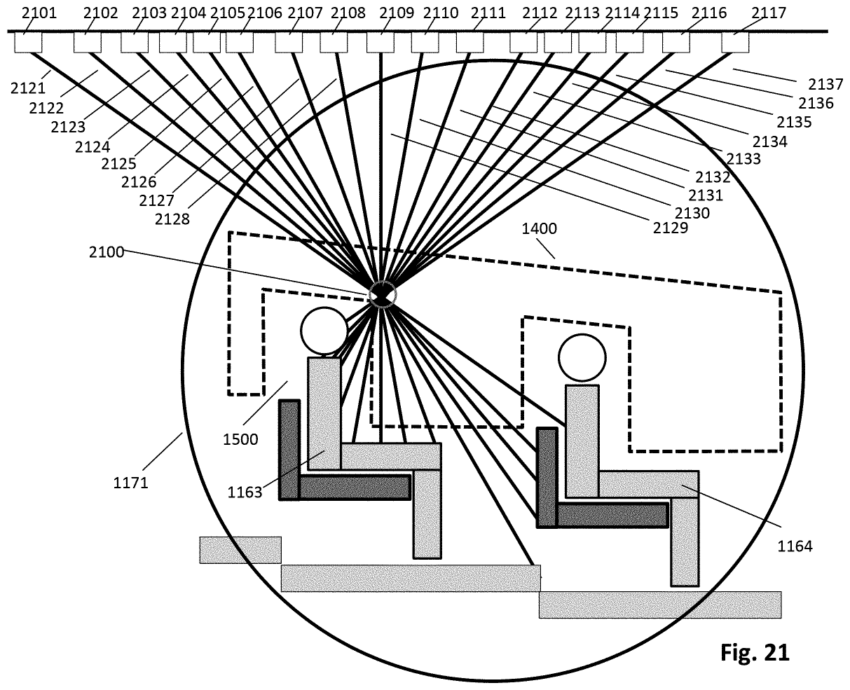

FIG. 21 shows another embodiment in which lasers are used to inactivate viruses in public spaces. FIG. 21 is the same as FIG. 15 in showing a detailed view of inactivation volume 1400, and of humans sitting in the public space in FIG. 14a, but unlike FIG. 15, FIG. 21 does not have transmit beams 1121-1132 from Antennas 1101-1112 in FIG. 14a that reach inactivation volume 1400 and users 1163 and 1164. Instead, FIG. 21 shows an embodiment with steerable laser units 2101-2117 that are overhead emitting laser beams 2121-2137 steered toward point in space 2100 in inactivation volume 1400. The laser units 2101-2117 can be mounted on the ceiling of the public space in FIG. 14a, on the walls of the public space in FIG. 14b, or on any other mountable locations, including but not limited to, a catwalk, rigging, pole, on the chairs, and on the floor.

Each of the laser beams 2121-2137 is of low enough power given the beamwidth and wavelength that, based on applicable safety guidelines (e.g. IEC, FDA, ANSI and others) that when the laser beam reaches any human, whether directly into the naked eye, on the skin, on clothes, or through glasses, given the duration of time that the laser is in one fixed position, that it will not harm the human. As can be seen in FIG. 21, several of the laser beams 2121-2137 reach the humans 1163 and 1164, including directly in the eye of human 1163. Despite directly reaching the humans, the power given the beamwidth will not harm humans. In one embodiment the steerable laser units 2101-2117 are IEC Class 1 lasers and are steered and held in one position for less than 1 second, under IEC, FDA and ANSI guidelines, and thus they will not harm any human. In other embodiments the lasers are lower or higher power lasers that are steered in one position for a short enough duration to not be harmful to humans. In another embodiment, the lasers are pulsed on and off such that average power density given the interval while the lasers are pulsed on is not harmful to humans.

FIG. 21 shows the laser beams 2121-2137 all steered to a point in 3D space 2100 within inactivation area 1400. At point in space 2100, the power density is much higher than the power density would be from a single laser. In one embodiment, the lasers are phase-synchronous to one another, and in one embodiment some or all of the lasers are not-phase synchronous. In one embodiment, the lasers are synchronized such that the pulses from all the lasers are aligned over the time domain and transmitted at the same time, and in another embodiment the pulses are not aligned. In one embodiment the lasers are the same or similar wavelengths. In other embodiments some or all of the lasers are of different wavelengths. In one embodiment the combined power density of the lasers at point in space 2100 is higher than would be safe for human exposure, but high enough power density to inactivate the virus virions located at that point in space. Despite the fact that the power density of the combined laser beams 2121-2137 at point in space 2100 is higher than is safe for human exposure, as noted previously, the exposure to humans 1163 and 1164 is safe because each of the individual beams is limited to a safe power level give the duration of exposure. Thus, the combined laser beams 2121-2137 can achieve a high enough power density at point in space 2100 in inactivation volume 1400 to inactivate virus virions, even though that power density would be harmful to humans, while at the same time the laser beams 2121-2137 hitting humans 1163-1164 would not be harmful because they would reach the humans as individual beams, not as combined beams.

The steerable laser units 2101-2117 are shown in FIG. 21 for illustrative purposes as being in a 1 dimensional row, but in other embodiments they are distributed in a 2 dimensional array, for example, as a 100×100 array on a ceiling, or in a 3 dimensional array, for example, hanging from various heights from a ceiling and/or mounted on walls. Any 1-, 2- or 3-dimensional arrangement is possible and the prior sentence cites examples of embodiments, not limitations. Because the laser units are at different locations in 1-, 2- or 3-dimensional space, when their laser beams are steered to all converge to one point in space in the inactivation volume 1400, the beams are all arriving at one point in space from different angles and will leave that one point in space at different angles, and thus will be separated individual beams when they exit the inactivation volume and potentially reach humans. As such, placing the steerable lasers 2101-2117 at different locations in 1-, 2- or 3-dimensional space results in individual beams exiting the inactivation volume 1400, and thus the many separated laser beams each will be safe when they reach humans.

Just as the radio waves in FIG. 16 create many volumes of coherence 1600 by the Antennas 1101-1112 as they repeatedly sweep through the area of inactivation 1400 in a sweep cycle, with Antennas 1101-1112 constantly adjusting where the volumes of coherence are located as the inactivation volume changes, the steerable lasers 2101-2117 create many points in space 2100 by sweeping through the inactivation volume 1400 in a sweep cycle, with steerable lasers 2101-2117 constantly adjusting where the points in space 2100 are located as the inactivation volume changes. Just as each volume of coherence 1600 is transmitted for the duration of the dwell time required to inactivate the virus in FIG. 16, each point in space 2100 is transmitted for the duration of the dwell time required to inactivate the virus in FIG. 21. In the case of the dwell time for the laser beams 2121-2137 of FIG. 21, the dwell time must be short enough that no individual beam reaching a human will be harmful for that duration. As with the radio frequency embodiments previously described, a safety zone 1500 would be established to be certain that the inactivation volume shape changes when humans move so that the humans will never be reached by a point in space 2100.

In one embodiment LIDAR units 1301-1311 and 1341-1350 are used to determine the inactivation volume 1400 and the safety gap 1500. In another embodiment the steerable lasers 2107-2117 are configured as LIDAR systems and are used to determine the inactivation volume 1400 and the safety gap 1500 during their sweep cycle while inactivating virus virions. In another embodiment the steerable lasers 2107-2117 are configured as LIDAR systems and are used to determine the inactivation volume 1400 and the safety gap 1500 during one period of time and are used inactivate virus virions during another period of time.

The size of the point in space 2100 can be adjusted by choosing a larger or small laser beamwidth for the steerable laser units 2101-2117, and also by choosing different numbers and different angles of laser beams 2121-2137.

Many technologies are available for steering laser beams. In one embodiment, Micro-Electro-Mechanical Systems (MEMS) mirrors are used. The steerable laser 2101-2117 can be controlled by one or more controller 1030 or localized controllers. In one embodiment, a synchronization means is used so that all of the steerable laser units 2101-2117 move their beams synchronously with each other. The synchronization means can be through a wired or optical communications means among the steerable laser units 2101-2117, or it can be through a wireless or free-space optical communications means. This invention is not limited to any particular synchronization means. Since the steerable lasers 2101-2117 are in different locations in space, each will be steered to a different angle so that the beams meet each other at a particular x, y, z location in space 2100 within the inactivation volume 1400. A controller 1030 or similar computing means will calculate the x and y steering angle for each steerable laser 2101-2117 so that it intersects with a particular x, y, z location in space 2100. In one embodiment, if such an angle is beyond the range of a steerable laser 2101-2117, then the controller 1030 will turn off the laser for that particular x, y, z location in space 2100. In another embodiment, one or more controllers 1030 will control more than one group of steerable lasers 2101-2117 such that each group will provide coverage to different regions of the public space at once.

In one embodiment, a computing means such as controller 1030 will determine the position and/or steering angles by calibrating each steerable laser 2101-2117 prior to use as described above and then calibrating again as needed to keep the steerable lasers 2101-2117 in calibration. The position and/or steering of each laser 2101-2117 can be determined through a number of means including but not limited to having a calibration object with a known pattern (for example, a cube of known size with dots on its corners) and known location within the steerable range of one of more steerable lasers 2101-2117. The controller 1030 would direct each laser beam 2121-2137 to be steered to sweep across the calibration object while a video camera sensitive to the wavelength of the laser determines the steering angle of each laser as its beam aligns with known points (e.g. dots on the corners of a 3D cube) on the calibration object. The steered angular difference from one dot to another can be used to determine the relative angle of each steerable laser 2101-2117 to the calibration pattern and the position of each steerable laser 2101-2117 to each other through geometric calculations well-known to practitioners of ordinary skill in the art. Other embodiments can use other calibration means, including using reference points on objects in the public space (e.g. the edges of chairs) within the public space.

In one embodiment the steerable lasers 2101-2117 are configured with a safety means in which in which the laser will only remain on if the steering means is active. This feature is a safety mechanism to be sure the laser does not remain on in one position for a long time which could be hazardous if the laser power level is safe for brief exposure to humans, but not for long exposure. Also, in the event of a failure that affects multiple lasers at once, it also ensures that multiple lasers won't remain in one position with combined beams creating a point in space 2100 with high power density for a long time interval. Such a safety mechanism could be implemented in many ways. For example in the case of a MEMS-based steering means, if the MEMS-based steering means ceased to be in rapid motion, then the laser will be shut off. Detecting that the steering means is active can be accomplished through a variety of means including but not limited to having an LED shining light on one side of a MEMS mirror with a photosensor positioned on the other side of the MEMS mirror so that the photosensor is behind the mirror when the mirror is at one extreme of motion, and it is front of the mirror is at another extreme of motion. Thus, when the mirror is in rapid motion, the photosensor will detect rapid on-off-on-off changes from the LED light as the LED is blocked and then unblocked by the mirror, but if the mirror is not moving, or moving slowly, then the photosensor will detect the LED light being continuously on or off for a long period of time, which will indicate that the MEMS mirror is not moving rapidly, and will trigger the laser to shut off.

Because the steerable lasers 2101-2117 are too low power to penetrate the body individually if, for whatever reason, the lasers are steered to a point in space 2100 that would be within a human body, the lasers will never reach that point, each getting stopped on the outside of the body. Thus, the only risk is if the steerable lasers 2101-2117 are inadvertently steered to a point in space on the body's outer skin surface or in the eye. While the system would certainly be designed and tested to be sure such a situation did not occur with normal operation, to further mitigate this risk, ultraviolet-C lasers in the 202-222 nm range could be used. Ultraviolet-C light has been found to be effective in inactivating viruses and killing bacteria in aerosol form and also does not have adverse effects human skin and eyes are exposed to it at power density levels required for inactivation of viruses and bacteria [30],[31]. While there are not yet guidelines in place to establish that such power levels are safe for long-term exposure, the system would be designed and tested such that high power exposure to the surface of the skin and the eye is extremely unlikely, so the current presumptive safety of ultraviolet-C at high power would only be a further safety backup in the event of the extremely unlikely occurrence of a high power combination of steerable lasers 2101-2117 on the skin on in the eye. As ultraviolet-C human exposure guidelines come into effect, the system can be configured so the no combination of lasers will result in a higher power of ultraviolet-C light than such guidelines recommend.

In another embodiment the steerable lasers 2101-2117 are used both inactivating virions and as LIDAR units to determine the location of solid objects in the public space. The LIDAR functionality of each such steerable laser 2101-2117 would have information about the distance to a solid object from each beam, and the steerable lasers 2101-2117 could be configured such that each laser is turned off when the LIDAR reports a solid object outside of a particular range of distances. This can be used to ensure a laser is never used to combine with other lasers if it is reaching an object too far or too close in case such a situation would indicate the laser is potentially combining with other lasers outside of a safe region of space.

In another embodiment, the steerable lasers 2101-2117 are configured to turn off if they are steered to an angle that beyond a particular range of angles. This can be used to prevent the laser from combining with other lasers in a location that is unsafe. For example, the human head is usually looking from side to side, not upward, so if lasers are on the ceiling of a public space, then they are unlikely to reach an eye if they are pointing straight downward, but might reach an eye if they are at a very oblique angle. If the lasers are turned off when they are steered to a very oblique angle, this would prevent a combination of lasers (or any laser) from reaching a human eye in most situations.

### System Analysis

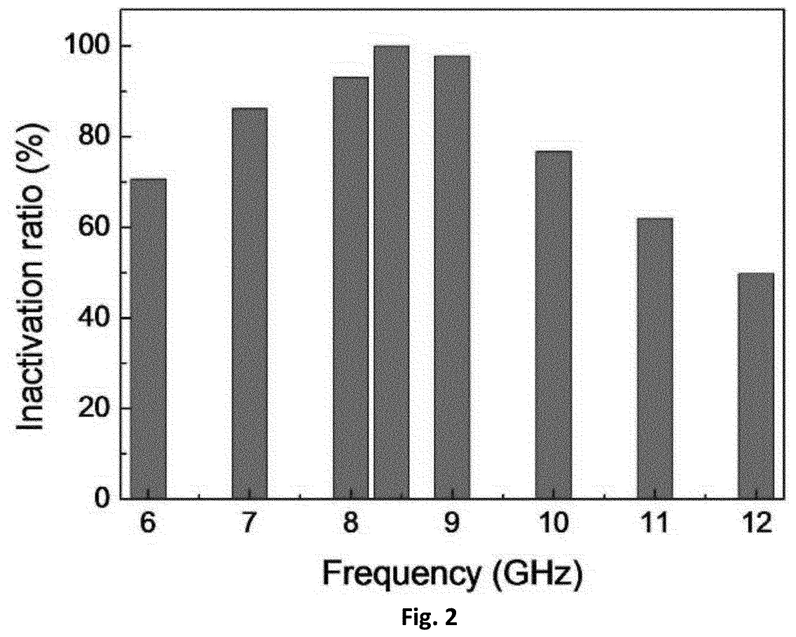

As one embodiment, we evaluate the transmit power requirement to rupture the capsid of the human rhinovirus (HRV) via EM radiation using an antenna array. The HRV, member of the picornaviridae family, is the major cause of the common cold. Application of the systems and methods described herein to the HRV is only one exemplary embodiment of the present invention, as the system disclosed in the present invention applies to any type of virus. The capsid of the HRV has icosahedral symmetry with diameter of 30 nm. We model the capsid as a perfect sphere and the virus as a homogeneous object with molecular mass=8.5×10⁶, according to the approximation in [10]. The capsid of the HRV consists of four proteins, namely VP1, VP2, VP3, and VP4. It has been reported that 20-minute hyperthermic treatment at 45° is able to suppress the reproduction of HRV by more than 90% [11]. By modeling the HRV as a homogeneous isotropic sphere it was shown that vibrational modes are able to absorb infrared radiation [12]. In the following results we assume EM radiation at 60 GHz, but similar results can be obtained at the resonant frequency of the HRV or other frequencies of the EM spectrum for different types of viruses. For Example, the experimental results in [32] reported in FIG. 2 show the influenza A subtypes H3N2 and H1N1 viruses have 100% inactivation ratio at the resonant frequency of 8.4 GHz.

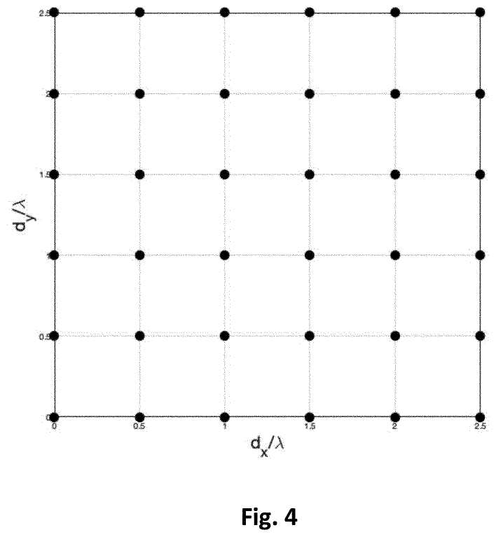

We model the transmit antenna array as a two-dimensional squared array (placed over the xy-plane) of infinitesimally small (lossless) dipoles, with current distribution over the y-axis. FIG. 4 shows an exemplary embodiment of the invention with the geometry of an antenna array arranged in a 6×6 matrix (each dot represents one antenna element). In a different embodiment of the invention, each element of the array is a dipole antenna, or a patch antenna, or any type of omnidirectional or directional antennas, or any combination of them. We assume far-field radiation such that the distance between the transmit array and the HRV satisfies the following condition

$$R > \frac{2 {L}^{2}}{λ}$$

where L is the largest dimension of the transmit array and λ is the wavelength. Under these assumptions, the power density of the radiated field at distance D from the array is given by

$${W}_{r ad} = \frac{NM \cdot {P}_{t}}{4 π {D}^{2}} \cdot \vert AF ( φ , θ ) \vert [ \frac{Watt}{{m}^{2}} ] \qquad ( 1 )$$

Note that in practical scenarios the antenna efficiency needs to be included in (1) to account for antenna losses. The array factor AF(ϕ,θ) in (1) for two dimensional squared arrays of N×M antennas (i.e., ideal isotropic radiators) is given by

$$AF {=}^{Δ} \frac{1}{NM} \frac{sin ( \frac{N {ψ}_{x}}{2} )}{sin ( \frac{{ψ}_{x}}{2} )} \frac{sin ( \frac{M {ψ}_{y}}{2} )}{sin ( \frac{{ψ}_{y}}{2} )}$$

and

ψₓ=kₓd=kₒdₓ sin θ cos ϕ+βₓ ψ_{y}=k_{y}d=kₒd_{y} sin θ sin ϕ+β_{y}

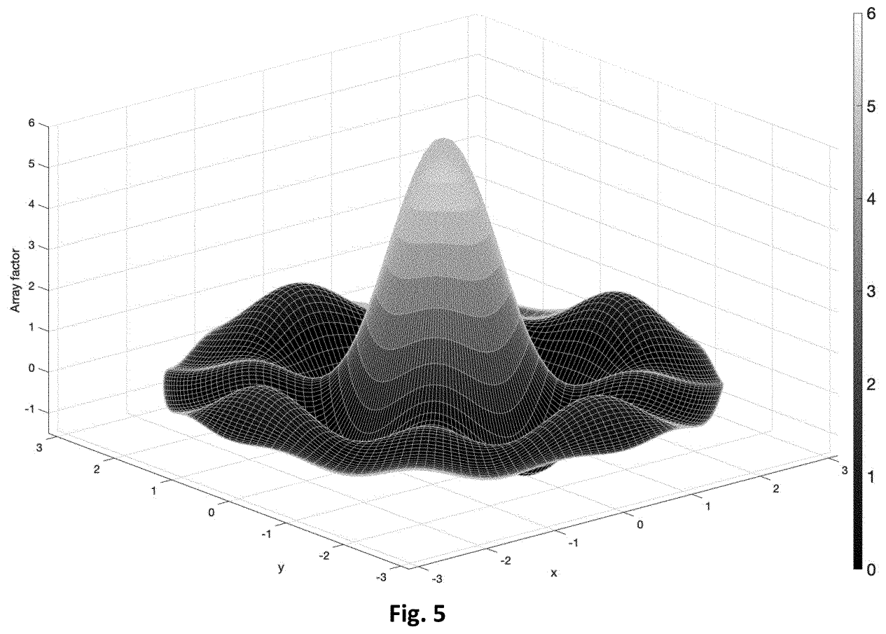

FIG. 5 shows the array factor for the exemplary 6×6 antenna array in FIG. 4.

In one embodiment, the antenna array is a broadside array (i.e., maximum radiation towards the broadside direction) such that βₓ=β_{y}=0. In a different embodiment of the invention, the direction of maximum radiation is any direction in the azimuth or elevation planes. In one embodiment, the elements of the antenna array are spaced half-wavelength apart (dₓ=d_{y}=λ/2) to avoid grating-lobe effects. In a different embodiment of the invention, the antenna spacing is any value lower or higher than half-wavelength to intentionally create grating lobes. In one embodiment, the grating lobes are created to reduce the beamwidth of the main lobe. In another embodiment, the grating lobes are controlled to manifest in specific directions and their radiated power is suppressed by means of electromagnetic (EM) absorbing material or EM shielding methods.

Next we compute the power absorbed by the HRV in far field as in [13]

P_{abs}=S·A·W_{rad} [Watt] (2)

where S is the relative absorption cross section (RACS) and A=πR² is the geometric cross section of the HRV (modeled as a perfect sphere) with radius R=15 nm. For a homogeneous sphere with R<<1 the RACS is given by [13]

$$S = \frac{4524 \cdot R \cdot σ}{{( 2 + {ɛ}_{r} )}^{2} + {( \frac{σ}{2 π {f}_{c} {ɛ}_{o}} )}^{2}}$$

where σ [S/m] is the conductivity of the capsid of the HRV, εᵣ is the dielectric constant of the capsid of the HRV, ε₀=8.854·10⁻¹² F/m is the permittivity of the air and f_{c} is the carrier frequency of the impinging EM radiation. We observe that the power loss due to the RACS is direct proportional to the square of the carrier frequency, similarly to the Friis' law in wireless communications links. Since the conductivity and dielectric constant of the protein in the HRV capsid are not available, we use the following values for phantom liquids in the experiments described in [14] at 2.45 GHz: σ=1.8 S/m and εᵣ=39.2.

The power absorbed by the HRV is converted in heat according to the following equation

$${P}_{a b s} = \frac{4 \cdot 18 \cdot V \cdot h \cdot m \cdot ΔT}{Δ t} [ Watt ] \qquad ( 3 )$$

where V=4πR³/3 is the volume of the HRV modeled as a sphere, h [cal/gram/° C.] is the specific heat of the capsid, m [gram/cc] is the specific weight of the capsid, ΔT [° C.] is the temperature rise of the capsid and Δt [sec] is the exposure time of the capsid to the EM radiation. Since the specific heat of the capsid is unknown, we use the value of specific heat of water that is h=1 cal/gram/° C. Similarly, we use the specific weight of water at 30° C. defined as m=0.996 gram/cc.

Finally, substituting (1) in (2) and equaling (2) and (3) we derive the transmit power requirement to heat the capsid of the HRV as

$${P}_{t} = \frac{4 π {D}^{2}}{S \cdot A \cdot AF ( φ , θ )} \cdot \frac{4 \cdot 18 \cdot V \cdot h \cdot m \cdot ΔT}{Δ t} [ Watt ] \qquad ( 4 )$$

### Results

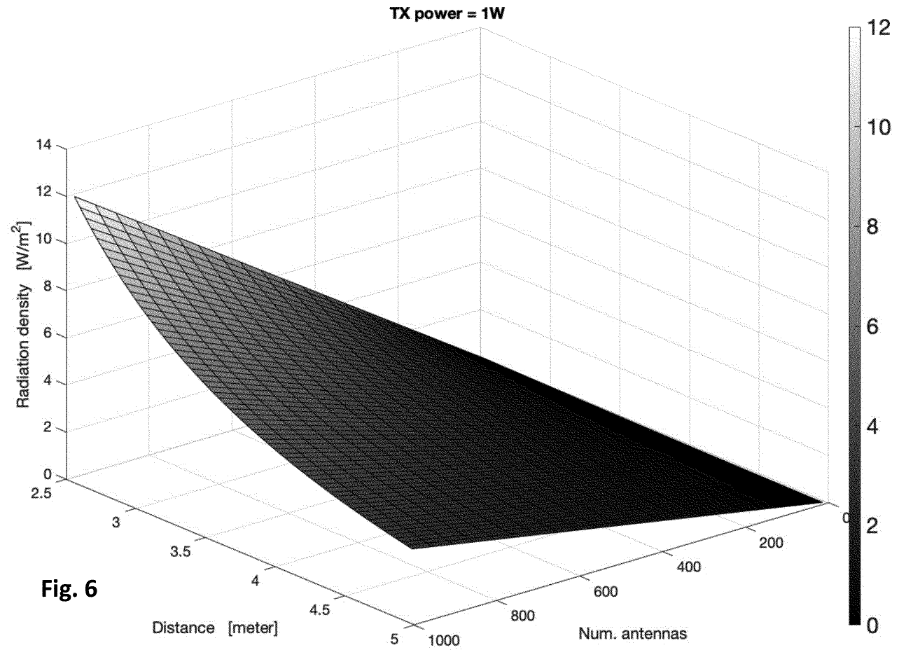

We first compute the power density in (1) as a function of distance (in the far-field region) and number of transmit antennas in the broadside direction. We assume 1 W input power to the array. Results are shown in FIG. 6. We observe that the power density decreases as a function of the distance, due to the spherical wave factor, and increases with the number of antennas, due to the array factor (AF).

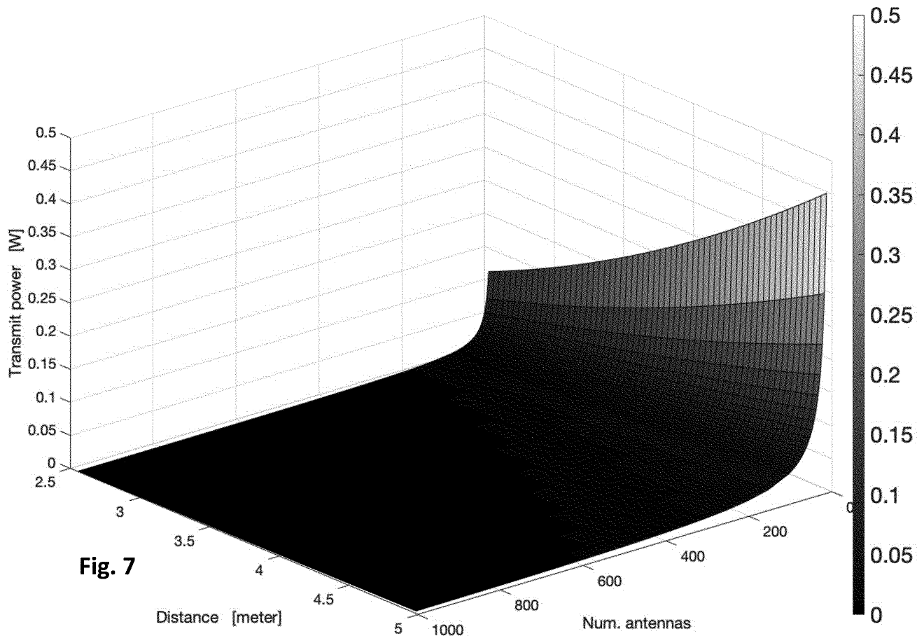

Next, we compute from (4) the transmit power requirement to rupture the capsid of the HRV by increasing the temperature from 30° C. to 45° C. for 20 minutes [11]. The power is expressed as a function of the number of transmit antennas and distance of the HRV from the transmit array as shown in FIG. 7. In one embodiment of the invention, the antenna array is placed closer to the surface to be swept to reduce the transmit power requirement to rupture the virus. In a different embodiment of the invention, different antennas of the arrays are dynamically selected throughout the venue depending on their distance from the surface to be swept by the beam.

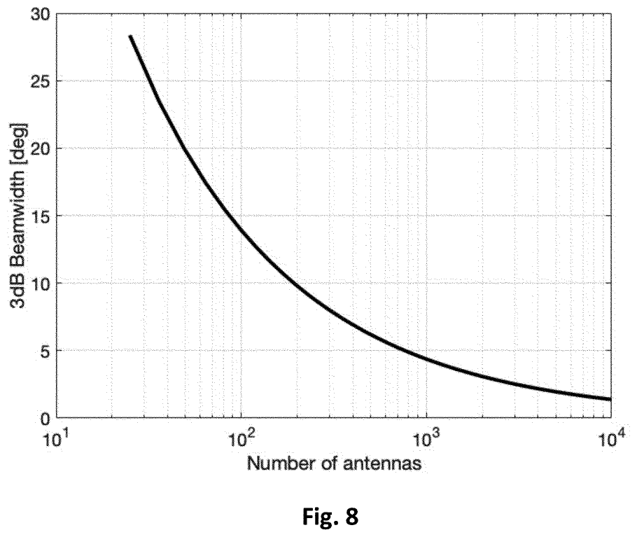

Focusing the energy to one point in space is an important feature of the proposed system, due to reduced power consumption and better safety. We evaluate the focusing capability of the transmit array in terms of −3 dB beamwidth as a function of the number of antennas in the squared array, as depicted in FIG. 8. In one embodiment of the invention, the array beamwidth is dynamically adjusted by selecting the number or types (e.g., omnidirectional versus directional) of active antennas depending on the conditions of operation of the system. For example, if the system must be operated while people occupy the venue, then the antenna array can be reconfigured to use narrower beams to increase focusing capability to the inactivation volume 1300 and avoid harmful radiation towards the safety gap 1500 or human bodies 1163. In another exemplary embodiment, in empty venues (e.g., once the event is over) the beam of the array is reconfigured for wider beamwidth to cover larger surfaces, thereby reducing time required to swipe the beams across the entire venue.

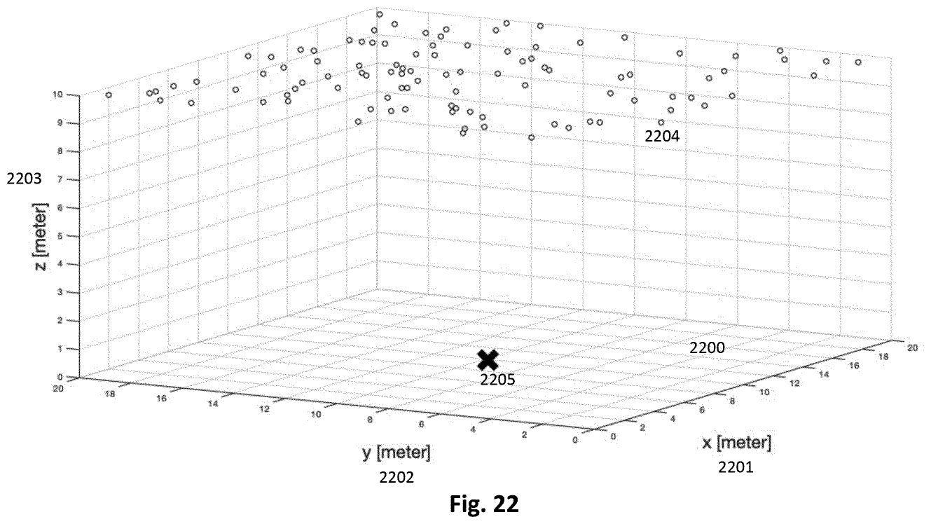

In one exemplary embodiment of the invention, we consider multiple antenna arrays installed on the ceiling or catwalks of an arena. FIG. 22 shows one squared section of the arena 2200 of dimensions 20 meters by 20 meters over the x and y axes 2201 and 2202, respectively, representing the seating area 1161 and 1162 in FIGS. 11a and 11b. The antenna arrays are installed at a height of 10 meters along the z axis 2203 from the seating area. FIG. 22 shows an exemplary embodiment of the invention with 100 antenna arrays, wherein each circle 2204 represents one antenna array. The target virus 2205 is the inactivation volume 1300 at the level of the seating area.

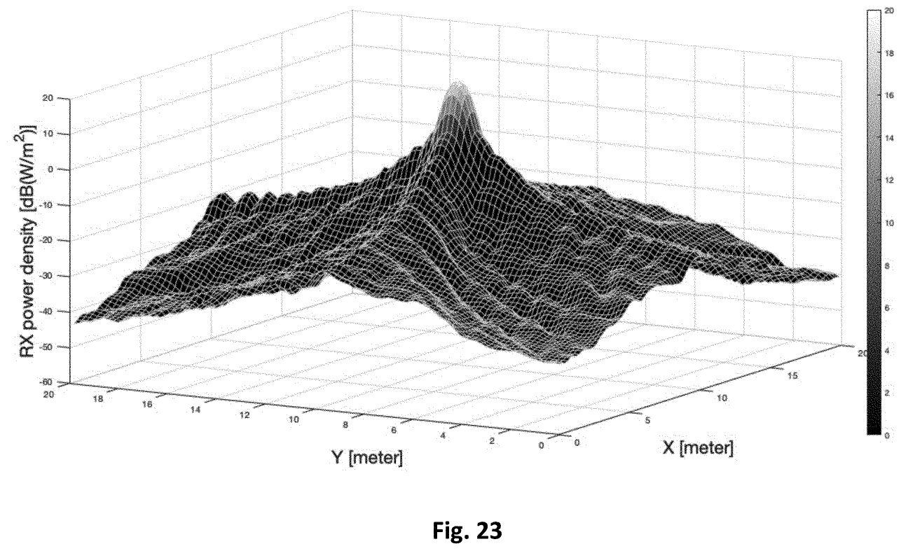

We use the model in (1) to simulate the power density radiated by the 100 antenna arrays 2204 at each point of the seating area 2200 of the arena. In this exemplary embodiment, the antenna array consists of a 32×32 matrix with a total of 1024 antenna elements yielding array gain of 30.1 dBi. Note that we model the antenna array using the array factor in (1) that assumes the antenna elements are ideal isotropic radiators. In practical scenarios, the same array gain and beamwidth is obtained with lower number of antenna elements, if each antenna element is a directional antenna (e.g., patch antennas). Further, the transmit power at the input of each antenna array is 20 mW. FIG. 23 shows the distribution of the power density (expressed in dB(W/m²)) over the portion of the arena in FIG. 22. The peak received power density is achieved at the location of the virus in the middle of the squared seating area and is equivalent to 106.5 W/m². We observe that because all the beams of the respective distributed antenna arrays 2204 point to the same location in space and/or the distributed antenna arrays employ beamforming, MRT or pCell precoding methods, the system and methods disclosed in this invention achieve sufficient power density at the target location 2205 to inactivate the virus while guaranteeing the power density everywhere else in the arena is below the FCC, ICNIRP or IEEE exposure safety limits.

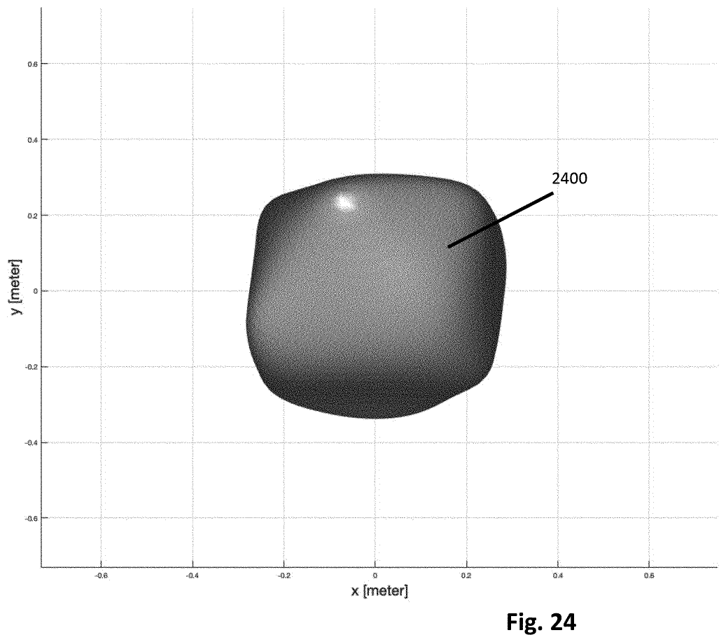

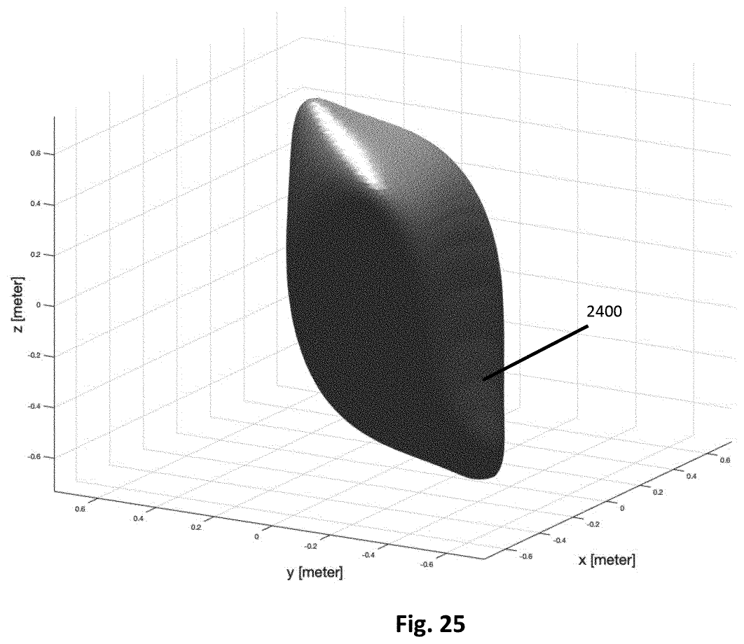

Next, we simulate the size of the volume in space where the power density is within the EM radiation exposure guidelines of 10 W/m² by the FCC and ICNIRP. We use the same parameters as the simulation in FIG. 23 except that in this case each antenna array consists of 10,000 ideal isotropic radiators to reduce the array beamwidth and increase the capability of the array to focus RF energy around the location of the virus. As observed before, in practice lower number of antenna elements is used if the antenna array design comprises directional antenna elements. FIG. 24 shows a top 3D view of what we refer to herein as the “safety boundary” 2400 of the volume in space outside of which the FCC and ICNIRP safety limits are met. FIG. 25 depicts a side 3D view of the same safety boundary 2400. In one embodiment of the invention, the safety boundary defines the boundary of the volumes of coherence 1600 in FIG. 16 within the inactivation volume 1400. In one embodiment of the invention, the safety boundary 2400 consists of only one enclosed volume. In a different embodiment, the safety boundary 2400 comprises the union of multiple volumes in space.

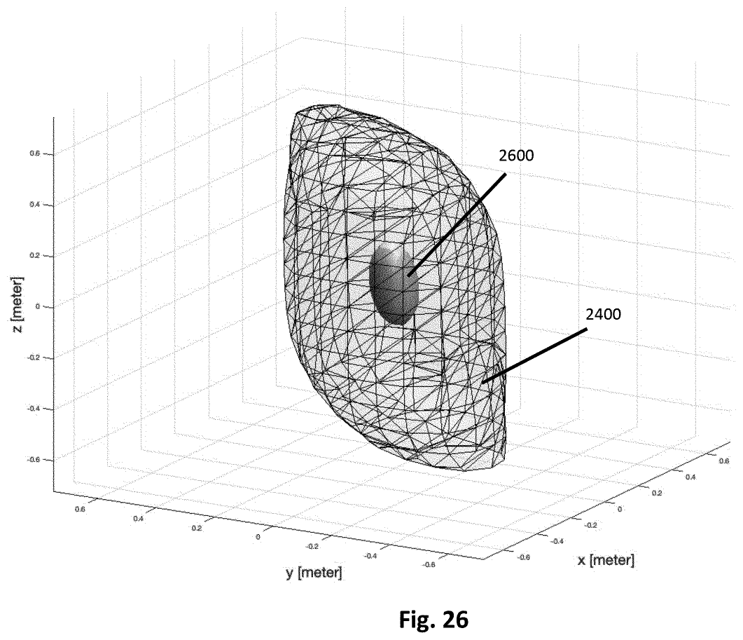

By definition, the power density inside the safety boundary 2400 is higher than the FCC and ICNIRP safety limits. It is not guaranteed, however, that power density is high enough to inactivate the virus everywhere inside the safety boundary 2400. Therefore, we define the “inactivation boundary” as the boundary of volume in space within which the power density is high enough to inactivate the virus with a given inactivation ratio. For example, [32] shows that power density of 810 W/m² is required to achieve 100% inactivation of influenza A subtypes H3N2 and H1N1 viruses at the resonant frequency of 8.4 GHz. Then, using the same parameters as the simulation in FIG. 25, we compute the inactivation boundary 2600 corresponding to power density of 810 W/m² shown in FIG. 26 as the smaller volume indicated by 2600. The larger volume 2400 indicates the same safety boundary 2400 from the same side view in FIG. 25 and from a top view in FIG. 24, but represented in FIG. 26 as a 3D translucent mesh so the encapsulated inactivation boundary 2600 within it is visible. We observe that within the volume between the safety boundary 2400 and the inactivation boundary 2600 there may be enough power density to inactivate the virus by a lower inactivation ratio. For example, [32] shows that different levels of power density above the limit of 10 W/m² inactivate viruses with lower inactivation ratio than 100%. In one embodiment of the invention, the inactivation boundary 2600 is encapsulated within the safety boundary 2400. In different embodiments of the invention, the safety boundary 2400 coincides or is encapsulated within the inactivation boundary 2600. For example, if the power density required to inactivate viruses with a given inactivation ratio is below the safety limit, then the safety boundary 2400 is encapsulated within the inactivation boundary 2600. We observe that because the transmissions from the distributed antenna arrays 2204 are coherently combined through beamforming, MRT or pCell precoding methods, the system and methods disclosed in this invention achieve sufficient power density at the target location 2205 to inactivate the virus while guaranteeing the power density everywhere else in the arena is below the FCC, ICNIRP or IEEE exposure safety limits even in presence of fast-fading.

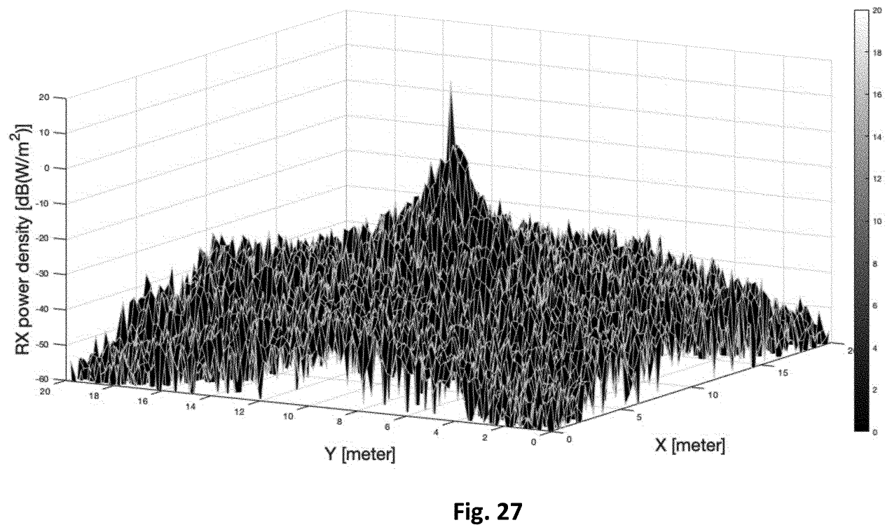

The above simulations assume free-space propagation model as in (1), which is reasonable assumption if the target virus 2205 has line-of-sight (LOS) to the antenna arrays 2204. In presence of slow- or fast-fading, it is still possible to achieve a peak in power density at the location of the target virus. For example, by adding fast-fading to the model in (1) and under the same assumptions as FIG. 23, the area that exhibits levels of received power density above the safety target is smaller as shown by the sharper peak in FIG. 27. In this case, also the safety boundary 2400 and the inactivation boundary 2600 will be smaller than in FIG. 26.

The above embodiments can be applied to inactivating or killing other pathogens such as bacteria and other microbes.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices. Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

### REFERENCES

[1] Babincova, M., Sourivong, P., and Babinec, P., “Resonant absorption of ultrasound energy as a method of HIV destruction,” Med. Hypotheses 55, pp. 450-451, 2000.
[2] Dykeman, E. C. and Sankey, O. F., “Low Frequency Mechanical Modes of Viral Capsids: An Atomistic Approach”, Physical Review Letters, vol. 100, 028101, 2008.
[3] Schirber, M., “New Way to Kill Viruses: Shake Them to Death,” LiveScience, http://www.livescience.com/health/080205-virus-shattering.html, access Feb. 9, 2008.
[4] Tsen, K.-T, et. al., “Inactivation of viruses by coherent excitations with a low power visible femtosecond laser,” Virology Journal, vol. 50, No. 4, 2007.
[5] Creative Virucide, Ideas on Deactivating Viruses, “Energy Absorption & Capsids,” http://virology.wordpress.com/2007/02/15/absorption-spectra-capsid-bursting/, accessed Feb. 10, 2008.
[6] Creative Virucide, Ideas on Deactivating Viruses, “Lattice Vibration Destruction,” http://virolgy.wordpress.com/2007/02/16/lattice-vibration-destruction/accessed Feb. 10, 2008.
[7] Tutwiler, R. L., “Ultrasonic Beamforming Architectures,” Proc. SPIE Vol. 3341, p. 43-54, Medical Imaging 1998: Ultrasonic Transducer Engineering, K. Kirk Shung; Ed.
[8] Van Veen, B. D. and Buckley, K. M., “Beamforming: A Versatile Approach to Spatial Filtering,” IEEE ASSP Magazine, Vol. 5, no. 2, pp. 4-24, April 1988.
[9] Frizzell, L. A.; Benkeser, P. J.; Ocheltree, K. B.; Cain, C. A., “Ultrasound Phased Arrays for Hyperthermia Treatment”, IEEE Ultrasonics Symposium, Page(s):930-935, 1985
[10] Murray, D. B. and Saviot, L., “Damping by bulk and shear viscosity for confined acoustic phonons of a spherical virus in water”, Journal of Physics: Conference Series 92 (2007) 012036, Phonons 2007, doi:10.1088/1742-6596/92/1/012036
[11] Conti, C., De Marco, A., Mastromarino, P., Tomao, P., and Santoro, M. G., “Antiviral Effect of Hyperthermic Treatment in Rhinovirus Infection”, Antimicrobial Agents and Chemotherapy, Vol. 43, No. 4, p. 822-829, April 1999
[12] Duval, E., “Far-infrared and Raman vibrational transitions of a solid sphere: selection rules” Phys. Rev. B 46 5795-5797, June 1992
[13] Anne, A. “Scattering and Absorption of Microwaves by Dissipative Dielectric Objects: The Biological Significance and Hazards to Mankind”, Ph.D. thesis, Technical report No. 36, The Moore School of Electrical Engineering, University of Pennsylvania, July 1963
[14] Fukunaga, K., Watanabe, S., and Yamanaka, Y., “Time dependence of dielectric properties of tissue-equivalent dielectric liquid materials”, IEEE Inter. Symp. On Electr, 2002
[15] Radcliffe, S., “How Long Will It Take to Develop a Vaccine for Coronavirus?”, Healthline, Jan. 30, 2020, https://www.healthline.com/health-news/how-long-will-it-take-to-develop-vaccine-for-coronavirus#Clinical-trials-are-rate-limiting-step
[16] “Severe acute respiratory syndrome coronavirus 2”, Wikipedia, https://en.wikipedia.org/wiki/Severe_acute_respiratory_syndrome_coronavirus_2
[17] Heally, J., Kovleski, S., “The Coronavirus's Rampage Through a Suburban Nursing Home”, The New York Times, Mar. 27, 2020, https://www.nytimes.com/2020/03/21/us/coronavirus-nursing-home-kirkland-life-care.html
[18] Ries, J., “Here's How COVID-19 Compares to Past Outbreaks”, Healthline, Mar. 12, 2020, https://www.healthline.com/health-news/how-deadly-is-the-coronavirus-compared-to-past-outbreaks#2009-(H1N1)-flu-pandemic
[19] Secon, H., Woodward, A., “About 95% of Americans have been ordered to stay at home. This map shows which cities and states are under lockdown.”, Business Insider, https://www.businessinsider.com/us-map-stay-at-home-orders-lockdowns-2020-3
[20] van Doremalen, N., et al., “Aerosol and surface stability of HCoV-19 (SARS-CoV-2) compared to SARS-CoV-1”, New England Journal of Medicine, Mar. 13, 2020, https://doi.org/10.1101/2020.03.09.20033217
[21] Kampg, G., et al., “Persistence of coronaviruses on inanimate surfaces and their inactivation with biocidal agents”, Journal of Hospital Infection, Jan. 31, 2020, https://www.journalofhospitalinfection.com/article/S0195-6701(20)30046-3/pdf
[22] Page, J., Fan, W., Khan, N., “How It All Started: China's Early Coronavirus Missteps”, The Wall Street Journal, Mar. 6, 2020, https://www.wsj.com/articles/how-it-all-started-chinas-early-coronavirus-missteps-11583508932
[23] Yoon, D., Martin, T., “Why a South Korean Church Was the Perfect Petri Dish for Coronavirus”, The Wall Street Journal, Mar. 2, 2020, https://www.wsj.com/articles/why-a-south-korean-church-was-the-perfect-petri-dish-for-coronavirus-11583082110
[24] ] Robinson, J., “The soccer match that kicked off Italy's coronavirus disaster”, The Wall Street Journal, Apr. 1, 2020, https/www.wsj.com/articles/the-soccer-match-that-kicked-off-italys-coronavirus-disaster-11585752012
[25] Bhattacharya, S., “Coronavirus Cruise Captain and Crew on the Lockdown: ‘The Rulebook Was Thrown Out’”, The Wall Street Journal, Feb. 26, 2020, https://www.wsj.com/articles/coronavirus-cruise-captain-and-crew-on-the-lockdown-the-rulebook-was-thrown-out-11582716677
[26] Craymer, L., “Virus Grounds a U.S. Aircraft Carrier as Crew Quarantined in Guam”, The Wall Street Journal, Apr. 1, 2020, https://www.wsj.com/articles/virus-grounds-a-u-s-arcraft-carrier-as-crew-quarantined-in-guam-11585736476
[27] Hagbom, M. et al. Ionizing air affects influenza virus infectivity and prevents airborne-transmission. Sci. Rep. 5, 11431; doi: 10.1038/srep11431 (2015)
[28] “What are ionizers and other ozone generating air cleaners?”, U.S. Environmental Protection Agency, https://www.epa.gov/indoor-air-quality-iaq/what-are-ionizers-and-other-ozone-generating-air-cleaners
[29] “Ozone Generators that are Sold as Air Cleaners,”, U.S. Environmental Protection Agency, https://www.epa.gov/indoor-air-quality-iaq/ozone-generators-are-sold-air-cleaners
[30] Welch, D., et al., “Far-UVC light: A new tool to control the spread of airborne-mediated microbial diseases”, Sci. Rep., Feb. 9, 2018, DOI:10.1038/s41598-018-21058-w, https://www.nature.com/articles/s41598-018-21058-w.pdf
[31] Kaidzu, S., et al., “Evaluation of acute corneal damage induced by 222-nm and 254-nm ultraviolet light in Sprague-Dawley rats”, Free Radical Res., June 2019, 53(6):611-617, doi: 10.1080/10715762.2019.1603378, https://www.ncbi.nlm.nih.gov/pubmed/30947566
[32] Yang, S.-C. et al., “Efficient Structure Resonance Energy Transfer from Microwaves to Confined Acoustic Vibrations in Viruses.” Sci. Rep. 5, 18030; doi: 10.1038/srep18030 (2015)
[33] Hung, W.-T., J.-J. Tung, and S.-Y. Chen (2014), A focusing reflectarray and its application in a handheld microwave virus sanitizer, Radio Sci., 49, 890-898, doi:10.1002/2014RS005481
[34] “IEEE Standard for Safety Levels with Respect to Human Exposure to Radio Frequency Electromagnetic Fields, 3 kHz to 300 GHz”, Federal Communications Commission, Apr. 19, 2006, http://emfquide.itu.int/pdfs/C95.1-2005.pdf
[35] “Evaluating Compliance with FCC Guidelines for Human Exposure to Radiofrequency Electromagnetic Fields, Supplement C (Edition 01-01) to OET Bulletin 65 (Edition 97-01)”, Federal Communications Commission, June 2001, https://transition.fcc.gov/bureaus/oet/info/documents/bulletins/oet65/oet65c.odf
[36] “Questions and Answers about Biological Effects and Potential Hazards of Radiofrequency Electromagnetic Fields, OET Bulletin 56, Fourth Edition”, Federal Communications Commission, August 1999
https://transition.fcc.gov/Bureaus/Engineering_Technology/Documents/bulletins/oet56/oet56e4.pdf
[37] S.-W. D. Tsen1, T. C. Wu, J. G. Kiang and K.-T. Tsen, “Prospects for a novel ultrashort pulsed laser technology for pathogen inactivation”, Journal of Biomedical Science 2012
[38] “Laser Product and Instruments”, U.S. Food and Drug Administration, Aug. 29, 2018, https://www.fda.gov/radiation-emitting-products/home-business-and-entertainment-products/laser-products-and-instruments
[39] R. M Woodward, B. E. Cole, V. P Wallace, R. J Pye, D. D. Arnone, E. H Linfield and M. Pepper, “Terahertz pulse imaging in reflection geometry of human skin cancer and skin tissue”, Physics in Medicine and Biology, 2002 https://iopscience.iop.org/article/10.1088/0031-9155/47/21/325/pdf
[40] R. Appleby, R. N. Anderton, “Millimeter-wave and submillimeter-wave imaging for security and surveillance”, Proceedings of the IEEE, 2007
[41] Cooper, K. B., Dengler, R. J., Llombart, N., Bryllert, T., Chatthopadhyay, G., Schlech, E., Gill, J., Lee, C., Skalare, A., Mehdi, I., et al., “Penetrating 3-d imaging at 4- and 25-m range using a submillimeter-wave radar”, IEEE Transactions on Microwave Theory and Techniques, 2008
[42] F. Adib, C.-Y. Hsu, H. Mao, D. Katabi, F. Durand, “RF-Capture: Capturing a Coarse Human Figure Through a Wall”, SIGGRAPH Asia 2015
[43] “Guidelines for Limiting Exposure to Electromagnetic Fields (100 kHz to 300 GHz)”, International Commission on Non-Ionizing Radiation Protection (ICNIRP), March 2020, https://www.icnirp.org/cms/upload/publications/ICNIRPrfqdl2020.pdf

We claim:

1. A system comprising:
a plurality of distributed antennas or radioheads configurated to transmit electromagnetic energy within a coverage area;
the electromagnetic energy tuned to a frequency which will kill or inactivate a pathogen;
a control means that coordinates the output of the distributed antennas or radioheads to concurrently create one or more high power volumes of electromagnetic energy in one or more locations in the coverage area; and
the control means to change the one or more locations of the one or more high power volumes of electromagnetic energy to a plurality of locations in the coverage area.

2. A method comprising:
transmitting electromagnetic energy from a plurality of distributed antennas or radioheads configurated within a coverage area, the electromagnetic energy tuned to a frequency which will kill or inactivate a pathogen;
coordinating the output of the distributed antennas or radioheads to concurrently create one or more high power volumes of electromagnetic energy in one or more locations in the coverage area;
changing the one or more locations of the one or more high power volumes of electromagnetic energy to a plurality of locations in the coverage area.
